(19) United States
(12) Patent Application Publication
(10) Pub. No.: US 2011/0291976 A1
(43) Pub. Date: Dec. 1, 2011

(54) TOUCH PANEL DEVICE, DISPLAY DEVICE EQUIPPED WITH TOUCH PANEL DEVICE, AND CONTROL METHOD OF TOUCH PANEL DEVICE

(75) Inventors: Masato Takada, Kanagawa (JP); Seigo Harashima, Kanagawa (JP); Yumiko Kawamura, Kanagawa (JP)

(73) Assignee: Ricoh Company, Ltd, Ohta-ku, Tokyo (JP)

(21) Appl. No.: 13/138,356

(22) PCT Filed: Mar. 2, 2010
(86) PCT No.: PCT/JP2010/053723

§ 371 Date: Aug. 5, 2011

(30) Foreign Application Priority Data
Mar. 12, 2009 (JP) 2009-060259
Jan. 18, 2010 (JP) 2010-008428

(51) Int. Cl. G06F 3/041

(52) U.S. Cl. 345/173

(57) ABSTRACT

A touch panel device includes an input screen page; an operation element generating unit configured to generate one or more operation elements to be displayed as one or more images on a display unit positioned underneath the input screen page; an oscillation generating unit configured to generate an oscillation for oscillating the input screen page; and a drive control unit configured to drive and control the oscillation generating unit with the use of a driving pattern for generating a standing wave having a waveform in accordance with positions of the one or more operation elements.

### TECHNICAL FIELD

The present invention relates to a touch panel device for displaying operation elements on a display screen and receiving operations input to a coordinate input screen page from an operator, a display device equipped with the touch panel device, and a control method of the touch panel device.

### BACKGROUND ART

An input device with a touch panel (hereinafter, “touch panel device”) is widely used as a display screen of ticket machines at train stations, ATMs (Automated Teller Machines) at financial institutions and convenience stores, and terminal devices such as mobile phones, music players, and game consoles.

A typical touch panel device is implemented by superposing a coordinate input screen page on a display screen such as a liquid crystal display, displaying operation elements such as buttons on the display screen, and providing services according to the operation elements touched by the operator on the coordinate input screen page. The operation elements such as buttons are typically GUI (Graphical User Interface) elements.

The GUI elements such as buttons can be freely arranged on such a touch panel device, which is highly convenient for both the manufacturer and the operator. Accordingly, demand for such touch panel devices is expected to increase.

When operating buttons are displayed on such a display screen, the operator does not feel the same sense of touch as that felt when operating actual buttons. Therefore, the operator may have a sense of uncertainty when operating such a display screen. For example, when the operator inputs an Operation (i.e., touches the touch panel) to press a button or to move a slide bar, the operator may think that operation has not been properly detected by the touch panel device. Thus, the operator may strongly press the display screen.

When a strong force is applied to the touch panel, the liquid crystal display may be damaged.

One approach is to display the touched button in an inverted color or to emit a sound when the operator inputs an operation, so that the operator can recognize that the touch panel device has detected the input by the operator.

However, visual and auditory perception differs among individuals. Furthermore, colors may appear to be different and sounds may sound different, depending on the location where the touch panel device is installed. Therefore, even by inverting the displayed color or emitting a sound when the operator inputs an operation, there are cases where the operator cannot sufficiently recognize that the touch panel device has detected the operator's input.

To address such operation-related problems, a touch panel device that provides a feeling (sense of touch) when the operator operates (touches) the touch panel device has been proposed. With this touch panel device, when an operator presses the touch panel, the touch panel starts to become displaced according to a signal waveform of a small oscillation amplitude, until the pressing force is determined as an input operation. Once the pressing force is determined as an input operation, this time the touch panel becomes displaced according to a signal waveform of a large oscillation amplitude. Accordingly, when the operator presses the touch panel, the operator first feels a stroke according to the small oscillation amplitude, and then feels a click according to the large oscillation amplitude (see, for example, Japanese Laid-Open Patent Application No. 2005-149197).

However, although the operator can feel a stroke with the above-described conventional touch panel device, the operator cannot immediately recognize the positional relationship between the operation element and his fingertip simply by feeling the stroke.

Thus, when an operator touches a button with his fingertip, he cannot immediately recognize whether the button is located on the left side or the right side of his fingertip.

Furthermore, if the operator's fingertip is located away from the button when he first touches the touch panel, the operator needs to visually recognize this by looking at the touch panel, and then press the button once again. Therefore, an operator with poor eyesight may have difficulty in using the touch panel.

Accordingly, there is a need for a touch panel device, a display device equipped with the touch panel device, and a control method of the touch panel device, with which the positional relationship between an operation element displayed on a display screen page and the fingertip of an operator can be immediately recognized based on only the perceived feeling by the operator.

### DISCLOSURE OF INVENTION

Aspects of the present invention provide a touch panel device, a display device equipped with the touch panel device, and a control method of the touch panel device.

An aspect of the present invention provides a touch panel device including an input screen page; an operation element generating unit configured to generate one or more operation elements to be displayed as one or more images on a display unit positioned underneath the input screen page; an oscillation generating unit configured to generate an oscillation for oscillating the input screen page; and a drive control unit configured to drive and control the oscillation generating unit with the use of a driving pattern for generating a standing wave having a waveform in accordance with positions of the one or more operation elements.

An aspect of the present invention provides a control method for controlling a touch panel device, including generating one or more operation elements to be displayed as one or more images on a display unit positioned underneath an input screen page; generating an oscillation for oscillating the display unit; and controlling the step of generating the oscillation with the use of a driving pattern for generating a standing wave having a waveform in accordance with positions of the one or more operation elements.

With the above configuration, a touch panel device, a display device equipped with the touch panel device, and a control method of the touch panel device can be provided, with which the positional relationship between an operation element displayed on a display screen page and the fingertip of an operator can be immediately recognized based on only the perceived feeling by the operator.

### BRIEF DESCRIPTION OF DRAWINGS

FIG. 1 is a cross-sectional view of a touch-panel-equipped display device (display device equipped with a touch panel) according to a first embodiment of the present invention;

FIG. 2 is a perspective view of a displayed screen of a liquid crystal panel of the touch-panel-equipped display device according to the first embodiment;

FIG. 3 is a block diagram of part of a circuit configuration included in a main control device of the touch-panel-equipped display device according to the first embodiment;

FIG. 4 is a block diagram of a circuit configuration of a standing wave generating circuit shown in FIG. 3;

FIGS. 5A and 5B illustrate the positional relationships between displayed GUI elements that are visible through a surface substrate of the touch-panel-equipped display device according to the first embodiment, and peak values of the amplitude of a standing wave generated by the surface substrate;

FIG. 6 illustrates the positional relationship between displayed GUI elements that are visible through a surface substrate of the touch-panel-equipped display device according to the first embodiment, and peak values of the amplitude according to a unique oscillation mode generated on the surface substrate;

FIG. 7 illustrates another example of the positional relationship between displayed GUI elements that are visible through a surface substrate of the touch-panel-equipped display device according to the first embodiment, and peak values of the amplitude according to another unique oscillation mode generated on the surface substrate;

FIG. 8 illustrates the positional relationship between displayed GUI elements that are visible through a surface substrate of the touch-panel-equipped display device according to a modification of the first embodiment, and peak values of the amplitude according to a unique oscillation mode generated on the surface substrate;

FIG. 9 illustrates an example of a table stored in the memory of the touch-panel-equipped display device according to the first embodiment;

FIG. 10 is a flowchart of a process of generating a driving pattern executed by the main control device of the touch-panel-equipped display device according to the first embodiment;

FIGS. 11A through 11C are property diagrams indicating the driving conditions when the operator first lightly touches a GUI button and then increases the pressing force on the GUI button in order to complete the operation, with the touch-panel-equipped display device according to the first embodiment;

FIGS. 12A through 12C illustrate the relationship between the fingertip of the operator and the oscillation of the surface substrate, in another touch-panel-equipped display device according to a comparison example;

FIGS. 13A through 13D illustrate positional relationships between positions of the operator's fingertip and, peak values of amplitudes of standing waves generated on the surface substrate, in the touch-panel-equipped display device according to the first embodiment;

FIG. 14 is a flowchart of a process of generating a driving pattern executed by the main control device of a touch-panel-equipped display device according to a second embodiment of the present invention;

FIG. 15 is a cross-sectional view of a touch-panel-equipped display device according to a third embodiment of the present invention;

FIG. 16 is a flowchart of a process of generating a driving pattern executed by a main control device of the touch-panel-equipped display device according to the third embodiment;

FIG. 17 is a cross-sectional view of a touch-panel-equipped display device according to a fourth embodiment of the present invention;

FIGS. 18A and 18B illustrate examples of tables stored in a memory of the touch-panel-equipped display device according to the fourth embodiment;

FIG. 19 is a flowchart of a process of generating a driving pattern executed by a main control device of the touch-panel-equipped display device according to the fourth embodiment;

FIGS. 20A and 20B illustrate a driving pattern of a touch-panel-equipped display device according to a fifth embodiment of the present invention;

FIG. 21 is a top view of a coordinate input screen page of a touch-panel-equipped display device according to a sixth embodiment of the present invention;

FIG. 22 is a flowchart of a process of generating a driving pattern executed by the main control device of the touch-panel-equipped display device according to the sixth embodiment; and

FIGS. 23A and 23B illustrate displayed GUI elements visible through the surface substrate of the touch-panel-equipped display device according to the sixth embodiment, and positional relationships between the GUI elements and the peak values of amplitudes of standing waves generated on the surface substrate.

### BEST MODE FOR CARRYING OUT THE INVENTION

Embodiments of the present invention are described below with reference to the accompanying drawings.

### First Embodiment

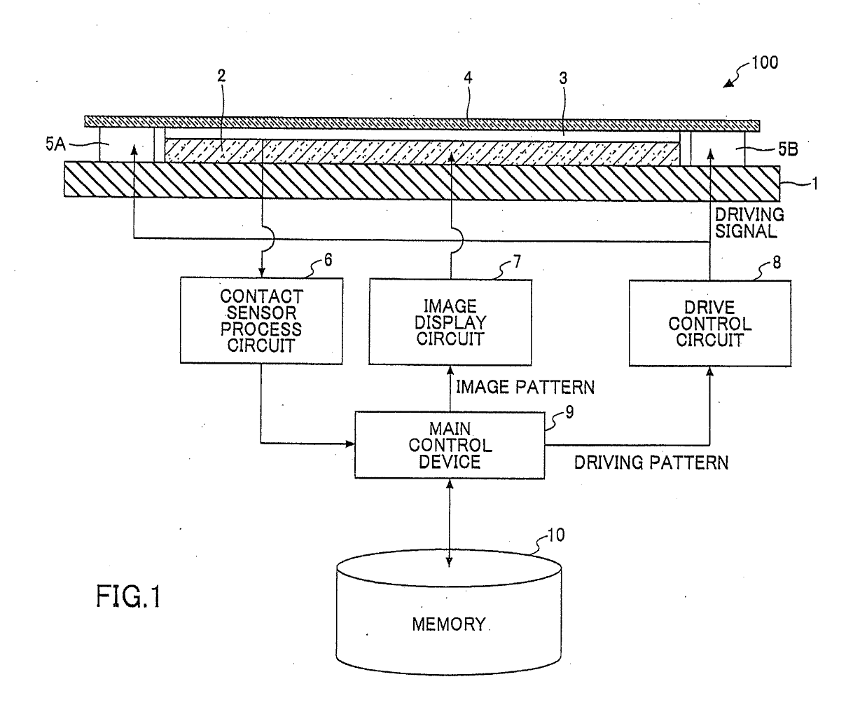

FIG. 1 is a cross-sectional view of a touch-panel-equipped display device (display device equipped with a touch panel) according to a first embodiment of the present invention.

A touch-panel-equipped display device 100 according to the first embodiment includes a base substrate 1, a liquid crystal panel 2, a contact sensor 3, a surface substrate 4, piezoelectrically-actuated devices 5A and 5B, a contact sensor process circuit 6, an image display circuit 7, a drive control circuit 8, a main control device 9, and a memory 10.

Among these elements, a touch panel device is constituted by the base substrate 1, the contact sensor 3, the surface substrate 4, the piezoelectrically-actuated devices 5A and 5B, the contact sensor process circuit 6, the image display circuit 7, the drive control circuit 8, the main control device 9, and the memory 10. That is to say, in the first embodiment, the touch panel device does not include the liquid crystal panel 2.

On the base substrate 1, the liquid crystal panel 2, the contact sensor 3, the surface substrate 4, and the piezoelectrically-actuated devices 5A and 5B are mounted. For example, the base substrate 1 may be a PCB (Printed Circuit Board) constituted by a glass-epoxy substrate or a glass composite substrate.

The liquid crystal panel 2 is mounted on the base substrate 1, and serves as a display unit for displaying GUI elements generated by the image display circuit 7. A display unit is not limited to the liquid crystal panel 2, as long as the display unit can display GUI elements. For example, an organic EL (Electro-Luminescence) panel may be used as the display unit instead of the liquid crystal panel 2.

The contact sensor 3 is mounted on the liquid crystal panel 2, and serves as a coordinate detecting device for detecting coordinates of a position pressed by the operator. In the first embodiment, a resistive sensor is used as the contact sensor 3. However, the contact sensor 3 is not limited to a resistive sensor; for example, the contact sensor 3 may be a pressure-sensitive sensor or a capacitance sensor.

The resistive sensor includes two electrode sheets facing each other. Each electrode sheet includes plural transparent electrodes arranged at predetermined intervals, in the form of a matrix. When the operator presses the surface of the surface substrate 4 with his fingertip, opposite electrodes contact each other and become conductively connected to each other. As opposite electrodes contact each other at a particular position, the resistance value changes at the particular position along an X direction and Y direction in each electrode sheet. Due to the change in the resistance value, a voltage value that is output from the resistive sensor changes at the particular position along the X direction and Y direction of each electrode sheet. Due to the change in the voltage value, the coordinates of the position pressed by the operator can be specified.

The surface substrate 4 is a transparent substrate serving as an operation input unit of the touch-panel-equipped display device 100. When the operator presses the surface of the surface substrate 4, the contact sensor 3 detects the coordinates of the pressed position (operation position). Therefore, the surface of the surface substrate 4 serves as a coordinate input screen page for operating the touch panel device according to the first embodiment. The surface substrate 4 may be a resin substrate made of acrylic or polycarbonate, or a glass substrate.

The piezoelectrically-actuated devices 5A and 5B are package-type driver elements. In each driver element, plural laminated thin sheets of piezo elements are sandwiched by electrode plates, which are accommodated in a casing made of resin. As shown in FIG. 1, the piezoelectrically-actuated devices 5A and 5B are sandwiched between the base substrate 1 and the surface substrate 4, and disposed on opposite sides of the liquid crystal panel 2 and the contact sensor 3. Actually, the piezoelectrically-actuated devices 5A and 5B are long thin driver elements having a length that is substantially the same as that of the base substrate 1 and the surface substrate 4 in the depth direction of the sheet as viewed in FIG. 1. When a voltage is applied, the piezoelectrically-actuated devices 5A and 5B are bent and displaced in the vertical direction of the laminated structure. Therefore, the piezoelectrically-actuated devices 5A and 5B serve as an oscillation generating unit for generating oscillation on the surface substrate 4.

The contact sensor process circuit 6 is for performing a signal process on the voltage value corresponding to coordinates of the pressed position, whereby the voltage value is output from contact sensor 3. According to this signal process, the voltage value corresponding to coordinates of the pressed position is subjected to amplification, noise removal, and digital conversion, so that the voltage value is output as a digital voltage value. Because a signal process is performed as described above, the pressed position can be can be precisely detected even if the voltage value output from the contact sensor 3 is small. Furthermore, by using a resistive sensor as the contact sensor 3 in which plural transparent electrodes are arranged in a matrix, the following advantages can be achieved. That is, the contact area (size of the area where the opposite electrode sheets of the contact sensor 3 contact each other) can be determined from the number of pairs of electrodes that have come in contact as the operator presses the liquid crystal panel 2. Moreover, the center position of the contact area can be calculated so that the operation position (contact position) can be precisely determined. Furthermore, the contact sensor process circuit 6 can detect the temporal changes in the operation position and the contact area.

Furthermore, the contact sensor 3 and the contact sensor process circuit 6 also function as a pressing force detecting unit for detecting the pressing force when the operator inputs an operation to the coordinate input screen page.

The contact sensor process circuit 6 performs the above signal process on the voltage value corresponding to coordinates of the operation position, and outputs input coordinate information expressing the position where the operation has been input, as well as area information expressing the contact area. For example, the input coordinate information may be coordinates of the center position of the area where the operation has been input, and the area information may be the size of the contact area. As the pressing force applied by the operator increases, the contact area where the opposite electrode sheets of the contact sensor 3 contact each other increases. Therefore, the resistance value between the electrode sheets decreases, and the voltage value expressing the area information output from the contact sensor process circuit 6 decreases. Conversely, as the pressing force decreases, the contact area decreases. Therefore, the voltage value expressing the area information increases. Changes in the area information may be used as information expressing changes in the pressing force on the surface substrate 4 applied by the operator. The input coordinate information and the area information is input to the main control device 9, as information expressing details of the operation input by the operator.

The image display circuit 7 is for displaying an image by driving the pixels of the liquid crystal panel 2. For example, in a case where the liquid crystal panel 2 is driven as an active matrix, the image display circuit 7 drives a TFT (Thin Film Transistor) to drive the pixels, based on the image data and the display coordinate data input from the main control device 9. The image display circuit 7 converts image data read from the memory 10 by the main control device 9 into analog voltage signals, and outputs the converted signals to drive the liquid crystal panel 2. Accordingly, an image (image pattern) corresponding to the image data is displayed on the liquid crystal panel 2 at a display position corresponding to the display coordinate data. The image data is stored in the memory 10, and is used for generating images (image patterns) of GUI elements that are operation elements of the touch-panel-equipped display device 100 and areas around the GUI elements. Furthermore, the display coordinate data is for specifying a position of the image data on the coordinates, and is stored in the memory 10 in association with the image data.

The drive control circuit 8 is for outputting a driving voltage (driving signal) for driving the piezoelectrically-actuated devices 5A and 5B. For example, a function generator may be used as the drive control circuit 8. The drive control circuit 8 performs modulation and amplification of the voltage waveform of the driving voltage in accordance with a driving pattern input from the main control device 9, to drive the piezoelectrically-actuated devices 5A and 5B. The driving pattern is determined by the frequency and amplitude of the voltage waveform, and the frequency and amplitude of the voltage waveform are set by frequency data and amplitude data that is read from the memory 10 by the main control device 9.

The main control device 9 may be, for example, a CPU (Central Processing Unit), which is a processing device for controlling the entire touch-panel-equipped display device 100 according to the first embodiment.

In the first embodiment, when the main control device 9 provides a predetermined service to the operator by executing a program stored in the memory 10, the main control device 9 determines what the operation input by the operator is, based on input coordinate information or area information input from the contact sensor process circuit 6, as well as the data expressing the type of GUI element displayed on the liquid crystal panel 2.

Furthermore, the main control device 9 executes a process according to the determination result, reads image data from the memory 10 for generating image patterns necessary for the process, and causes the liquid crystal panel 2 to display the image patterns via the image display circuit 7.

For example, in a case where the touch-panel-equipped display device 100 according to the first embodiment is used in an ATM, the main control device 9 causes the liquid crystal panel 2 to display GUI elements corresponding to buttons used for inputting a PIN (personal identification number) or an amount of money according to an operation by the operator. Furthermore, the main control device 9 executes a process for dispensing cash or transferring cash, according to operation input by the operator.

In the touch-panel-equipped display device 100 according to the first embodiment, image data is stored in the memory 10 in association with amplitude data, frequency data, and phase difference data.

The main control device 9 functions as a drive control unit. Specifically, when reading the image data from the memory 10 and displaying the image on the liquid crystal panel 2 to provide a predetermined service as described above, the main control device 9 reads the amplitude data, frequency data, and phase difference data that is associated with the image data in the memory 10, and drives the piezoelectrically-actuated devices 5A and 5B via the drive control circuit 8 to execute a process of oscillating the surface substrate 4. Details of the process of oscillating the surface substrate 4 are given below.

The memory 10 is for storing various data items such as programs required for driving the touch-panel-equipped display device 100 according to the first embodiment. In the first embodiment, the memory 10 stores programs for providing predetermined services, image data, display coordinate data, amplitude data, frequency data, and phase difference data.

Image data is used for displaying images of GUI elements and other images to be displayed on the liquid crystal panel 2. Display coordinate data is used for specifying coordinates of the position where the image corresponding to the image data is to be displayed.

The amplitude data, frequency data, and phase difference data is for expressing driving patterns used for driving the piezoelectrically-actuated devices 5A and 5B via the drive control circuit 8.

The amplitude data, frequency data, and phase difference data for expressing driving patterns is stored in the memory 10 in association with the corresponding image data and display coordinate data.

Details of the method for driving the piezoelectrically-actuated devices 5A and 5B are given below. The touch panel device and the touch-panel-equipped display device 100 according to the first embodiment drive the piezoelectrically-actuated devices 5A and 5B such that antinodes (of a standing wave) are located at center positions of GUI elements corresponding to buttons displayed on the liquid crystal panel 2, and nodes (of the standing wave) are located at boundaries between the GUI elements.

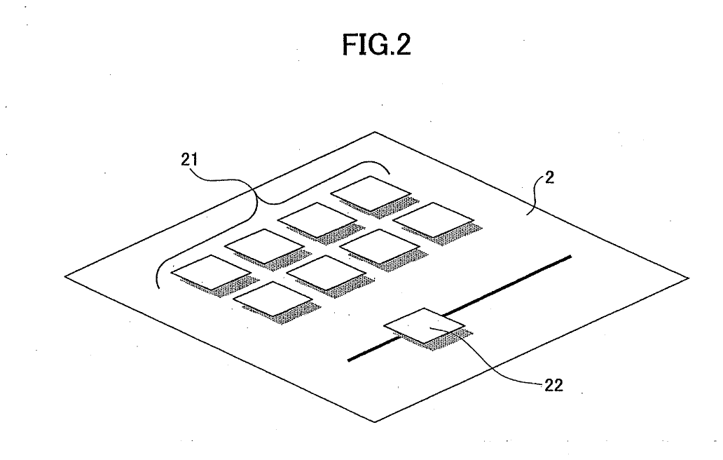

FIG. 2 is a perspective view of a displayed screen of the liquid crystal panel 2 of the touch-panel-equipped display device 100 according to the first embodiment.

The main control device 9 accesses the memory 10 with the use of an image pattern ID described below, and reads image data and display coordinate data corresponding to an image data ID associated with the image pattern ID. Then, when the main control device 9 inputs the image data and the display coordinate data in the image display circuit 7, the image display circuit 7 generates an image (image pattern) at a particular position on the liquid crystal panel 2, with the use of the image data and the display coordinate data. Accordingly, GUI elements including eight GUI buttons 21 and a GUI slide bar 22 are displayed on the liquid crystal panel 2.

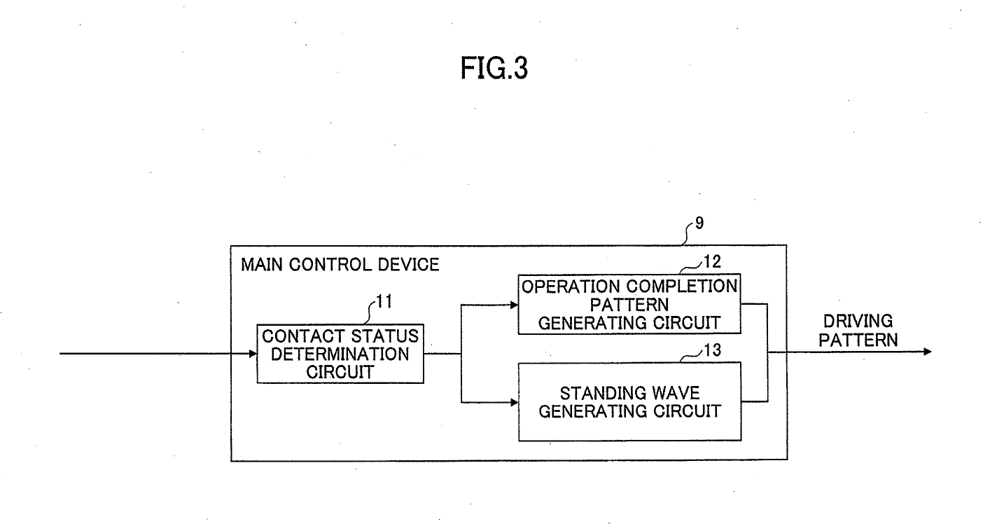

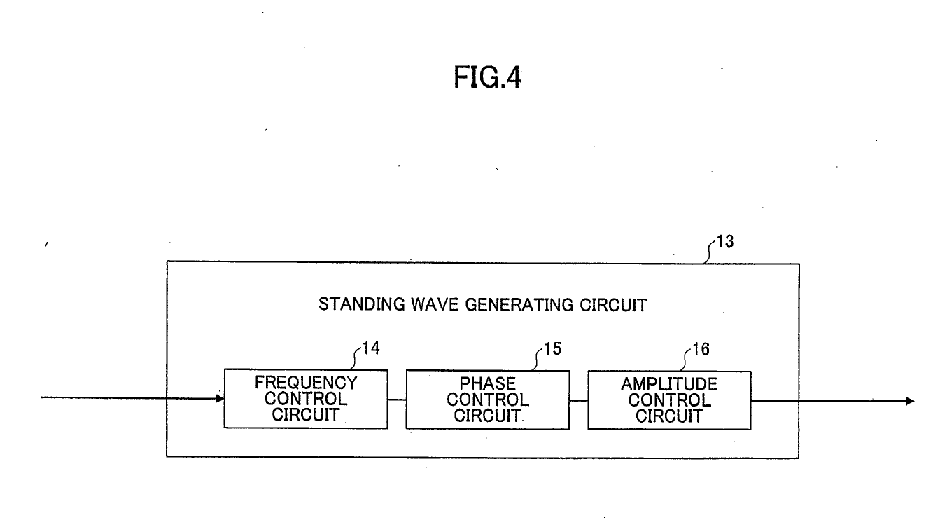

FIG. 3 is a block diagram of part of a circuit configuration included in the main control device 9 of the touch-panel-equipped display device 100 according to the first embodiment. FIG. 4 is a block diagram of a circuit configuration of a standing wave generating circuit shown in FIG. 3.

As shown in FIG. 3, the main control device 9 includes a contact status determination circuit 11, an operation completion pattern generating circuit 12, and a standing wave generating circuit 13. As described above, the main control device 9 is a processing device for controlling various processes of the touch-panel-equipped display device 100, and the circuit shown in FIG. 3 is a partial illustration of the main control device 9.

The contact status determination circuit 11 receives input coordinate information and area information from the contact sensor process circuit 6. Based on the area information, the contact status determination circuit 11 determines the amount of pressure force applied on the coordinate input screen page (surface of the surface substrate 4) by the operator (contact level). If the pressure force determined by the contact status determination circuit 11 is greater than or equal to a predetermined threshold, the main control device 9 causes the operation completion pattern generating circuit 12 to execute a process. If the pressure force determined by the contact status determination circuit 11 is less than a predetermined threshold, the main control device 9 causes the standing wave generating circuit 13 to execute a process.

There are two circuits for generating driving patterns to be input to the drive control circuit 8, and one of them is the operation completion pattern generating circuit 12. When the operator touches a GUI button or the slide bar displayed on the liquid crystal panel 2, the operation completion pattern generating circuit 12 generates a driving pattern for driving the piezoelectrically-actuated devices 5A and 5B, to provide a feeling by touch to notify the operator that the operation has been completed. “End of operation” means that the touch-panel-equipped display device 100 according to the first embodiment has detected that the operator has input an operation.

The standing wave generating circuit 13 is the other one of the two circuits for generating driving patterns to be input to the drive control circuit 8. When the operator touches a GUI button or the slide bar displayed on the liquid crystal panel 2, the standing wave generating circuit 13 generates a driving pattern for driving the piezoelectrically-actuated devices 5A and 5B, to provide a feeling by touch as if the operator is touching an actual button.

As shown in FIG. 4, the standing wave generating circuit 13 includes a frequency control circuit 14, a phase control circuit 15, and an amplitude control circuit 16.

The frequency control circuit 14 is for reading and outputting frequency data stored in the memory 10. The frequency control circuit 14 is included in the main control device 9, and therefore the process of reading the frequency data stored in the memory 10 performed by the main control device 9 is actually executed as the frequency control circuit 14 reads the frequency data in the memory 10.

The phase control circuit 15 is for reading and outputting phase difference data stored in the memory 10. The phase control circuit 15 is included in the main control device 9, and therefore the process of reading the phase difference data stored in the memory 10 performed by the main control device 9 is actually executed as the phase control circuit 15 reads the phase difference data in the memory 10.

The amplitude control circuit 16 is for reading and outputting amplitude data stored in the memory 10. The amplitude control circuit 16 is included in the main control device 9, and therefore the process of reading the amplitude data stored in the memory 10 performed by the main control device 9 is actually executed as the amplitude control circuit 16 reads the amplitude data in the memory 10.

When the frequency control circuit 14, the phase control circuit 15, and the amplitude control circuit 16 respectively read the frequency data, the phase difference data, and the amplitude data from the memory 10, the data that has been read is output from the standing wave generating circuit 13. Accordingly, driving patterns expressed by the frequency data, the phase difference data, and the amplitude data are input to the drive control circuit 8 from the main control device 9.

The frequency of the standing wave, the positions of the antinodes and nodes, and the amplitude may be adjusted by changing the frequency data, the phase difference data, or the amplitude data.

By changing the frequency data, the phase difference data, and the amplitude data, a driving pattern having plural superposed waveforms may be generated. Furthermore, the generated waveform is not limited to a sine wave; the generated waveform may be a pulse wave or a triangle wave. Furthermore, the driving pattern of the piezoelectrically-actuated device 5A and the driving pattern of the piezoelectrically-actuated device 5B may be the same or different.

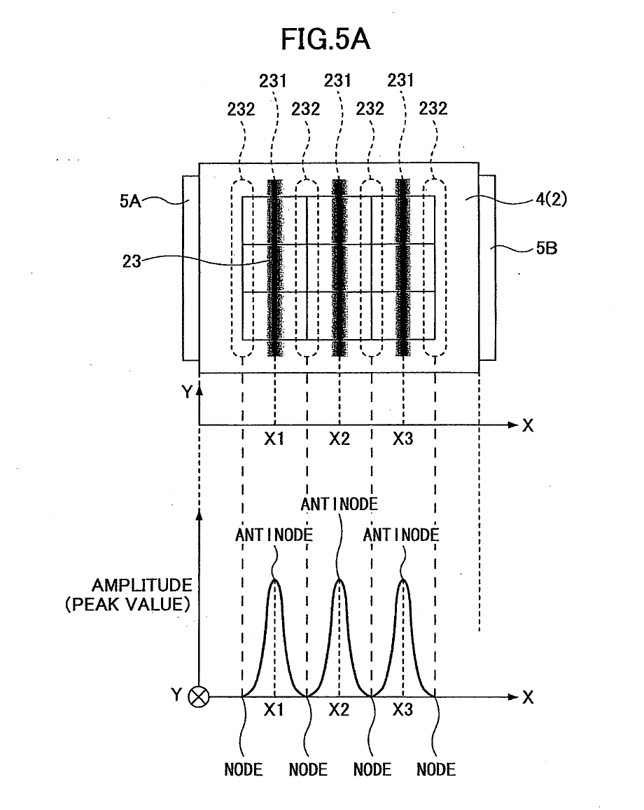

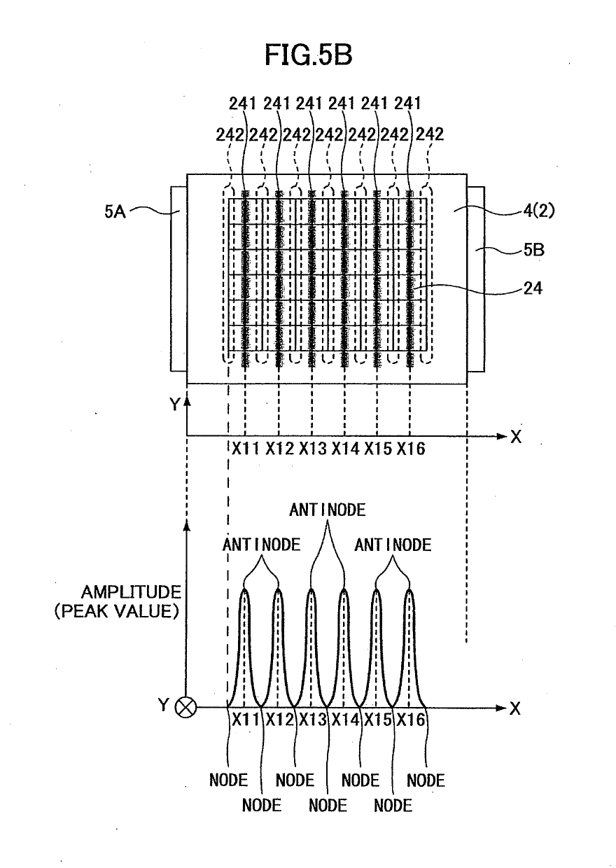

FIGS. 5A and 5B illustrate the positional relationships between displayed GUI elements visible through the surface substrate 4 of the touch-panel-equipped display device 100 according to the first embodiment, and the peak values of the amplitude of the standing wave generated by the surface substrate 4. FIG. 5A illustrates a case where nine GUI buttons 23 in a matrix of 3 rows and 3 columns are displayed as GUI elements. FIG. 5B illustrates a case where thirty-six GUI buttons 24 in a matrix of 6 rows and 6 columns are displayed as GUI elements.

In FIGS. 5A and 5B, the plan views at the top show the GUI buttons 23 and 24 that are displayed on the liquid crystal panel 2 and visible through the transparent surface substrate 4. Furthermore, the waveform diagrams shown at the bottom indicate amplitude profiles of peak values of amplitudes of the standing waves positioned along the X direction of the surface substrate 4. The plan view and the corresponding waveform diagram have common X and Y coordinates.

As shown in FIG. 5A, the generated standing wave has antinodes positioned at center positions 231 of the GUI buttons 23 and nodes positioned at the edges (boundaries 232) of the GUI buttons 23. Accordingly, by touching the coordinate input screen page (surface of the surface substrate 4), the operator can immediately recognize based on only the perceived feeling that a portion, which is oscillating more strongly than other portions on the surface of the surface substrate 4, corresponds to the center of one of the GUI buttons 23 in the X direction.

FIG. 5A illustrates a case where the standing wave generating circuit 13 has generated a standing wave in which the antinodes are positioned at the center positions 231 of the GUI buttons 23 (e.g., each GUI button 23 having a size of approximately 40 mm×30 mm) and the nodes are positioned at the boundaries 232. However, in another example, the standing wave generating circuit 13 may generate a standing wave in which the antinodes are positioned at the boundaries 232 and the nodes are positioned at the center positions 231 of the GUI buttons 23 in the X direction.

The positions and numbers of nodes and antinodes may be optionally set with the use of frequency data and phase difference data included in the driving pattern.

For example, as shown in FIG. 5B, when 36 GUI buttons 24 are displayed in a matrix of 6 rows and 6 columns, the standing wave generating circuit 13 generates a standing wave in which the antinodes are positioned at center positions 241 of each of six GUI buttons 24 arranged in the width direction and the nodes are positioned at boundaries 242.

When the size of the surface substrate 4 shown in FIG. 5B is the same as that of FIG. 5A, the size of the GUI buttons 24 is to be approximately half that of the GUI buttons 23 (for example, approximately 20 mm×15 mm). Thus, by driving the piezoelectrically-actuated devices 5A and 5B at a higher frequency than the standing wave shown in FIG. 5A, the nodes and antinodes of the standing wave can be positioned at the center positions 241 and the boundaries 242 of the GUI buttons 24 shown in FIG. 5B, which are relatively small buttons (compared to the GUI buttons 23).

In the above description, as shown in FIGS. 5A and 5B, the piezoelectrically-actuated devices 5A and 5B are arranged along the Y direction at the edges of the surface substrate 4 (i.e., the edges in the X direction), and therefore a standing wave is generated in the X direction. However, a standing wave may be generated in the Y direction by arranging two piezoelectrically-actuated devices along the X direction at the edges of the surface substrate 4 (i.e., the edges in the Y direction).

In the first embodiment, the touch-panel-equipped display device 100 may generate a standing wave according to a unique oscillation mode to adjust a unique oscillation frequency, so that antinodes of the standing wave are positioned at the GUI buttons 23.

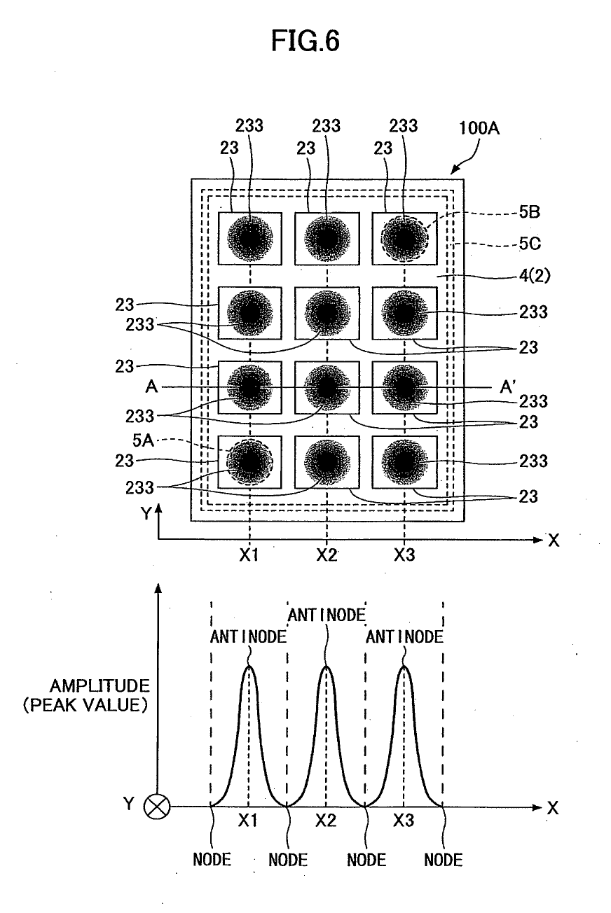

FIG. 6 illustrates the positional relationship between displayed GUI elements that are visible through the surface substrate 4 of a touch-panel-equipped display device 100A according to the first embodiment, and peak values of the amplitude according to a unique oscillation mode generated on the surface substrate 4. Among the standing waves, a standing wave according to the unique oscillation mode is generated by a distributed oscillation that is formed when waves are reflected at the edge portions of a physical body (fixed edges) and the waves are repeatedly superposed. By using a standing wave according to the unique oscillation mode, a desired oscillation distribution can be generated. Therefore, by adjusting the unique oscillation frequency, the antinodes of the standing wave can be generated at the GUI buttons 23.

In the touch-panel-equipped display device 100A shown in FIG. 6, the piezoelectrically-actuated devices 5A and 5B are arranged along a diagonal line of the surface substrate 4 as viewed from the top, and the surface substrate 4 is supported by a wall 5C on the base substrate 1 (see FIG. 1). These features are different from the touch-panel-equipped display device 100 shown in FIGS. 5A and 5B. The piezoelectrically-actuated devices 5A and 5B shown in FIG. 6 are cylindrical driving devices having a circular shape as viewed from the top. Furthermore, the wall 5C is a rectangular frame as viewed from the top, which is disposed along the four sides of the surface substrate 4. The wall 5C supports the surface substrate 4 on the base substrate 1. The parts of the surface substrate 4 that are fixed to the base substrate 1 by the wall 50 are referred to as the “fixed edges” in the unique oscillation mode.

The unique oscillation mode is excited under the following condition. For example, considering an example of a beam, the length of the beam needs to be an integral multiple of the half wavelength of a wave that is generated by oscillation. That is to say, the unique oscillation mode is determined by the material and the size of a physical body. For example, to obtain the frequency of a (m, n) mode (m, n being an arbitrary integer) of the surface substrate 4 that is a rectangular plate whose four sides are supported as shown in FIG. 6, the following formula (1) can be used. Specifically, the frequency is expressed by formula (1), where the surface substrate 4 has a Young's modulus E, a density ρ, a Poisson ratio ν, lengths Lx, Ly, a height h, and an angular frequency ω.

$${freq}_{m , n} = \frac{{ω}_{m , n}}{2 π} = \frac{π}{2 \sqrt{12}} \{ {( \frac{m}{{L}_{x}} )}^{2} + {( \frac{n}{{L}_{y}} )}^{2} \} h \sqrt{\frac{E}{ρ ( 1 - {v}^{2} )}} \qquad ( 1 )$$

For example, a polycarbonate transparent substrate having a Young's modulus of 2.5e⁹ [Pa], a density of 1,200 [kg/m³], a Poisson ratio of 0.38 is used as the surface substrate 4. The lengths and height of this surface substrate 4 are Lx=30 [mm], Ly=40 [mm], and h=1.21 [mm]. The piezoelectrically-actuated devices 5A and 5B are driven at 20 kHz for oscillating the surface substrate 4 to generate a distributed oscillation corresponding to (3, 4) mode that is distributed two-dimensionally, as shown in FIG. 6. The amplitude profile in the cross section cut along A-A′ shown in the top diagram in FIG. 6, is shown in the bottom diagram in FIG. 6. When GUI buttons 23 in a matrix of 4 rows and 3 columns are displayed in the top diagram in FIG. 6, antinodes 233 of the oscillation can be positioned at the GUI buttons 23. In FIG. 6, the antinodes 233 are illustrated by gradation, and the darker the gradation, the larger the amplitude. Furthermore, the nodes are located in between the antinodes 233.

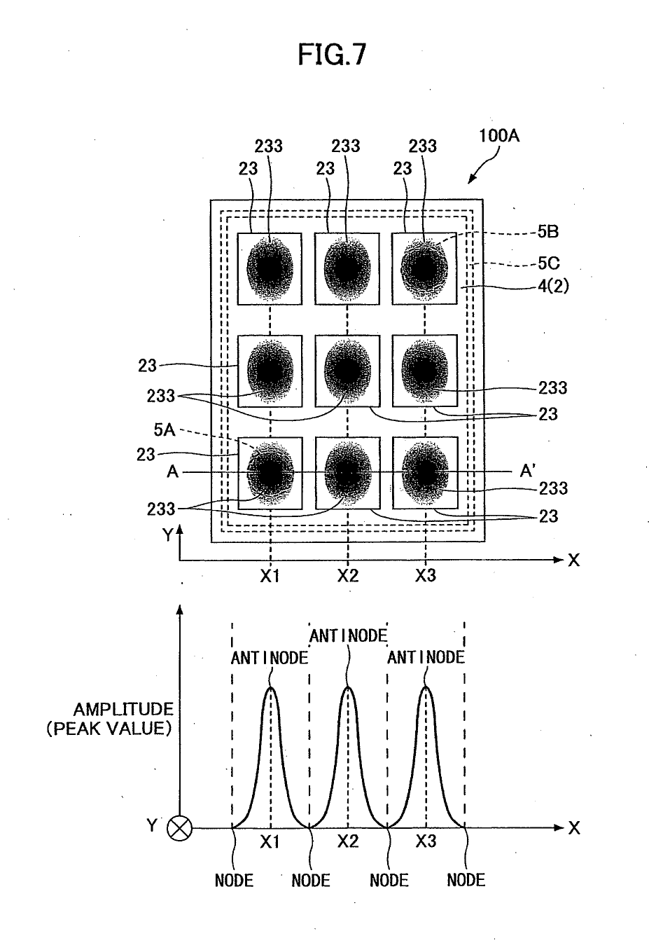

Furthermore, the unique oscillation frequency can be changed for exciting another unique mode to control the positions of the antinodes and nodes of the standing wave. For example, the piezoelectrically-actuated devices 5A and 5B are driven at 13.4 kHz to excite (3, 3) mode as shown in the top diagram of FIG. 7. The positions of the standing wave is adjusted with respect to the display positions of the GUI buttons 23 that are displayed in a matrix of 3 rows and 3 columns. The amplitude profile in the cross section cut along A-A′ shown in the top diagram in FIG. 7, is shown in the button diagram in FIG. 7. Thus, antinodes 233 of the standing wave can be positioned at center positions of the GUI buttons 23.

Such a unique oscillation mode has the following advantage. Specifically, even if the oscillation force exerted by the piezoelectrically-actuated devices 5A and 5B is small, a larger amplitude can be attained at the positions of the antinodes compared to the case of generating a standing wave that is not in the unique oscillation mode. Furthermore, the waves are reflected at the edge portions of a physical body (i.e., fixed edges formed by the wall 5C), and therefore an oscillation distribution may be formed even if there is only one oscillating point. That is to say, by adjusting the Young's modulus E, the density ρ, the Poisson ratio ν, the lengths Lx, Ly, the height h, and the angular frequency ω of the surface substrate 4, a standing wave can be generated by a unique oscillation with the use of a single piezoelectrically-actuated device. For example, only one of the piezoelectrically-actuated devices 5A and 5B shown in FIG. 6 may suffice.

As a matter of course, the more the oscillating points, the more stable the oscillation. The number of oscillating points can be increased by increasing the number of piezoelectrically-actuated devices. For example, in addition to the piezoelectrically-actuated devices 5A and 5B disposed beneath the bottom left and top right GUI buttons 23 in FIG. 6, there may be piezoelectrically-actuated devices disposed beneath the top left and bottom right GUI buttons 23, so that the surface substrate 4 is oscillated with the use of a total of four piezoelectrically-actuated devices.

In FIGS. 6 and 7, all four sides of the surface substrate 4 are supported on the base substrate 1 (see FIG. 1) by the wall 5C that is a rectangular frame. However, the wall 5C may not be shaped as a single frame; the wall 5C may be constituted by separate pieces of walls, as long as they are arranged along the four sides of the surface substrate 4. For example, the wall 5C that is a rectangular frame shown in FIGS. 6 and 7 may be disconnected at the four angles of the frame, such that four linear walls 5C are provided in parallel.

In FIGS. 6 and 7, the piezoelectrically-actuated devices 5A and 5B are disposed inside the wall 5C as viewed from the top, and the piezoelectrically-actuated devices 5A and 5B are disposed directly underneath the GUI buttons 23. However, in another example, the piezoelectrically-actuated devices 5A and 5B may be disposed outside the area where the GUI buttons 23 are displayed but inside the wall 5C, as viewed from the top.

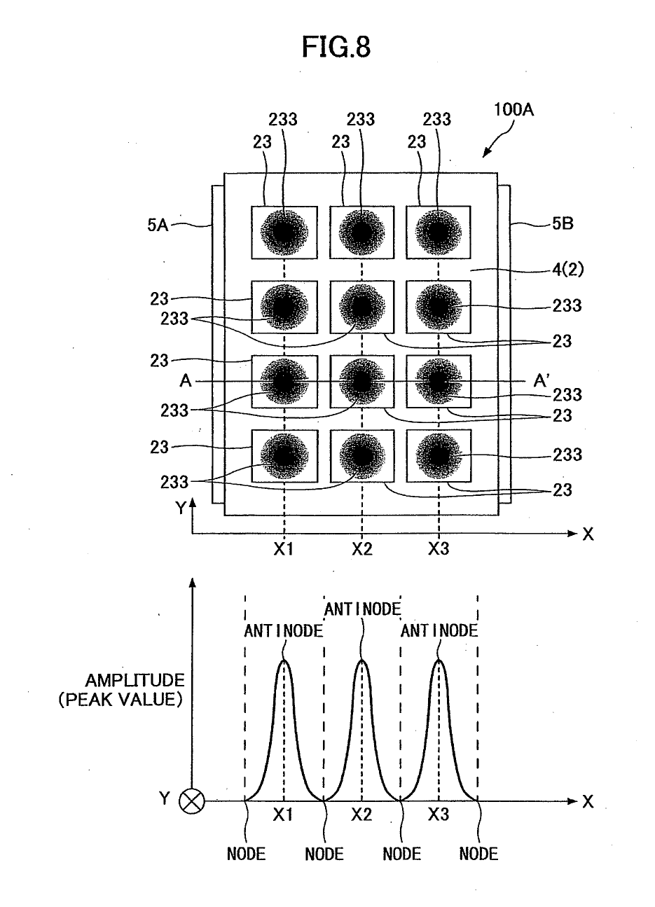

As shown in FIG. 8, by using linear piezoelectrically-actuated devices 5A and 5B extending in the Y axis direction similar to those shown in FIG. 5A, and adjusting the Young's modulus E, the density ρ, the Poisson ratio ν, the lengths Lx, Ly, the height h, and the angular frequency ω of the surface substrate 4, a standing wave can be generated such that the antinodes 233 are positioned at the GUI buttons 23. The amplitude profile in the cross section cut along A-A′ shown in the top diagram in FIG. 8, is shown in the button diagram in FIG. 8. The antinodes 233 of a standing wave generated by unique oscillation can be positioned at the GUI buttons 23.

The values indicated herein are merely examples, and other values may be applicable.

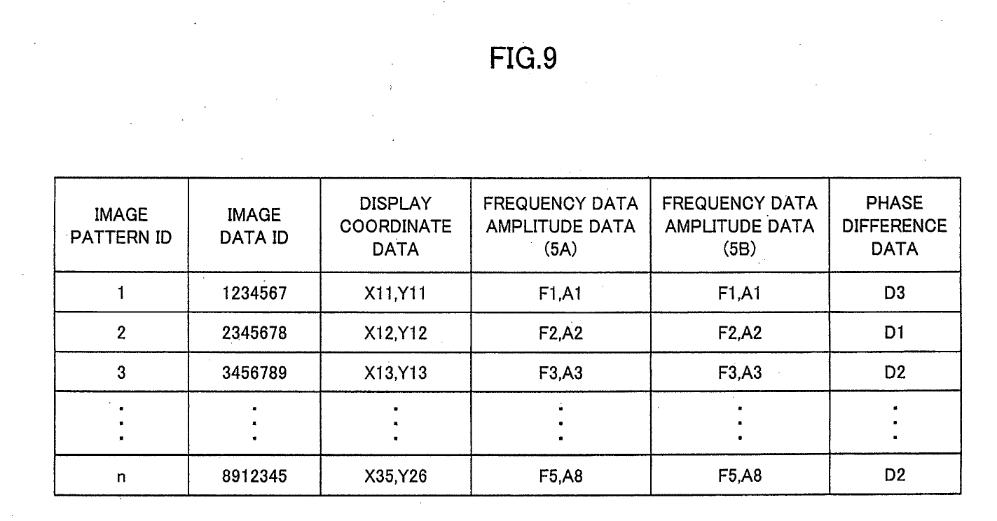

Next, with reference to FIG. 9, a description is given of a data structure for generating standing waves as illustrated FIGS. 5A and 5B.

FIG. 9 illustrates an example of a table stored in the memory 10 of the touch-panel-equipped display device 100 according to the first embodiment.

As shown in the table of FIG. 9, the memory 10 stores, in association with each other, an image pattern ID, an image data ID, display coordinate data, frequency data, amplitude data, and phase difference data.

The image pattern ID is used as an identifier (ID) for managing the image data ID, display coordinate data, frequency data, amplitude data, and phase difference data. The image pattern ID is given to an image pattern that is expressed by image data associated with the image pattern ID.

The image data ID represents the type of image data. The image data itself is stored in the memory 10 separately from the table shown in FIG. 2.

The display coordinate data expresses XY coordinates (X, Y) used for displaying the image pattern on the liquid crystal panel 2. The display coordinate data defines the position where to display the image pattern generated based on the image data.

The frequency data and the amplitude data express the frequency and the amplitude used for driving the piezoelectrically-actuated devices 5A and 5B. Frequency data and amplitude data are assigned to each of the piezoelectrically-actuated devices 5A and 5B. Frequency data F and amplitude data A are set in accordance with the image pattern.

The phase difference data expresses the phase difference in the frequency data used for driving the piezoelectrically-actuated devices 5A and 5B. The phase difference data is a positive or negative value expressing the phase difference between the frequency data of the piezoelectrically-actuated device 5A and the frequency data of the piezoelectrically-actuated device 5B.

As illustrated in FIGS. 5A and 5B, the frequency data, the amplitude data, and the phase difference data are expressed by values for generating a standing wave that corresponds to image patterns (i.e., shapes of GUI elements) expressed by image data identified by the image data IDs, so that nodes or antinodes of various standing waves are generated at center positions or boundaries of the GUI elements.

The main control device 9 reads the above-described data included in the table in the memory 10. Specifically, the main control device 9 uses the image pattern ID to read corresponding information including the image data ID, the display coordinate data, the frequency data, the amplitude data, and the phase difference data. Accordingly, images of GUI elements and images of areas surrounding the GUI elements are displayed on the liquid crystal display of the touch-panel-equipped display device 100 according to the first embodiment, so that predetermined services can be provided in response to operations input by the operator.

In the above example, the main control device 9 uses the image pattern ID to read corresponding information including the image data ID, the display coordinate data, the frequency data, the amplitude data, and the phase difference data. However, the method of reading the data is not so limited.

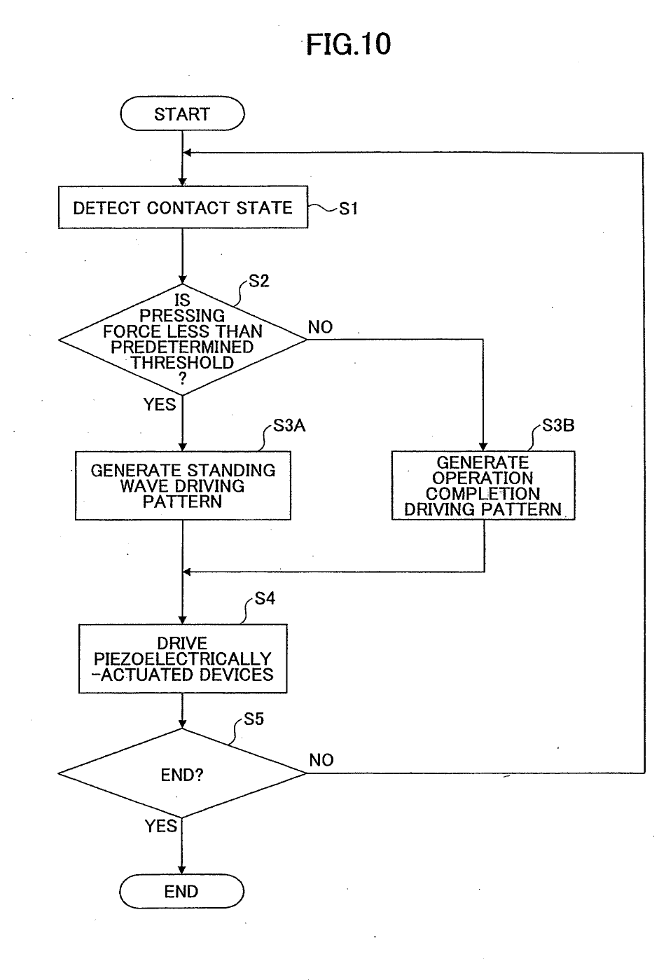

FIG. 10 is a flowchart of a process of generating a driving pattern executed by the main control device 9 of the touch-panel-equipped display device 100 according to the first embodiment. The process corresponds to a method of controlling the touch panel device according to the first embodiment.

When the touch-panel-equipped display device 100 according to the first embodiment is activated, the main control device 9 starts the process shown in FIG. 10 (START).

The touch-panel-equipped display device 100 according to the first embodiment initially displays a predetermined initial operation screen page on the liquid crystal panel 2.

When the touch-panel-equipped display device 100 is activated, the main control device 9 uses the image pattern ID of each GUI element to be displayed on the initial operation screen page to read corresponding information including an image data ID, display coordinate data, frequency data, amplitude data, and phase difference data from the table shown in FIG. 9. Then, the main control device 9 inputs the image data and display coordinate data associated with the image data ID in the image display circuit 7. Accordingly, the initial operation screen page is displayed on the liquid crystal panel 2.

As described above, at the initial stage, the touch-panel-equipped display device 100 according to the first embodiment is displaying the initial operation screen page on the liquid crystal panel 2, but the piezoelectrically-actuated devices 5A and 5B are not yet driven, and a standing wave is not yet generated on the surface substrate 4.

First, the main control device 9 detects a contact state on the coordinate input screen page (surface of the surface substrate 4) (step S1). The contact state is detected by detecting input coordinate information that is input from the contact sensor process circuit 6.

Next, the main control device 9 determines whether the pressing force on the coordinate input screen page (surface of the surface substrate 4) is less than a predetermined threshold (step S2). The determination of the pressing force is performed by the main control device 9 serving as a pressing force determining unit, based on a voltage value expressing area information that is input from the contact sensor process circuit 6.

When the pressing force is low (not pressed or lightly pressed), the voltage value expressing area information is high. When the pressing force is high (strongly pressed), the voltage value expressing area information is low. Accordingly, the determination process in step S2 is actually performed by determining whether the voltage value expressing area information exceeds a predetermined voltage threshold.

The processes in step S1 and S2 are executed by the contact status determination circuit 11 included in the main control device 9.

When the main control device 9 determines that the pressing force is less than a predetermined threshold in step S2, the main control device 9 generates a driving pattern (standing wave driving pattern) with the use of the frequency data, the amplitude data, and the phase difference data that is read from the memory 10 in advance when the touch-panel-equipped display device 100 is activated (step S3A).

The process in step S3A is performed by the frequency control circuit 14, the phase control circuit 15, and the amplitude control circuit 16 in the standing wave generating circuit 13.

After step S3A, the main control device 9 inputs, in the drive control circuit 8, the driving pattern (standing wave driving pattern) expressed by the frequency data, the amplitude data, and the phase difference data for generating a standing wave, and drives the piezoelectrically-actuated devices 5A and 5B (step S4).

Accordingly, oscillation is transferred to the surface substrate 4, and antinodes of the standing wave are generated at the center positions of the GUI element buttons. For example, as shown in FIG. 5A, antinodes of the generated standing wave are positioned at the GUI buttons 23.

Thus, when the operator touches the GUI button 23, the operator can recognize the outlines of the boundaries 232 of the GUI buttons 23 based on the oscillation of the standing wave. Therefore, the operator can immediately recognize the positions of the GUI buttons 23, based on only the feeling perceived by touching the coordinate input screen page (surface of the surface substrate 4).

As described above, when the pressing force is less than a predetermined threshold, a standing wave is generated on the surface substrate 4. This is because when the pressing force is less than a predetermined threshold, it is assumed that the operator is searching for the position of a target GUI button 23 in order to input an operation. Therefore, a standing wave is generated so that the operator can immediately recognize the position of the GUI button 23 based on only the feeling perceived by touching the surface substrate 4.

Conversely, when the main control device 9 determines that the pressing force is greater than or equal to the predetermined threshold in step S2, the main control device 9 reads, from the memory 10, a driving pattern (operation completion driving pattern) for generating an oscillation for the GUI button 23, so that the operator is notified that the operation has been completed based on the perceived feeling (step S3B).

After step S3B, in step S4, the main control device 9 inputs the driving pattern (operation completion driving pattern) generated in step S3B to the drive control circuit 8, and drives the piezoelectrically-actuated devices 5A and 5B.

The operation completion driving pattern may be any pattern as long as the frequency, the phase difference, or the amplitude for driving the piezoelectrically-actuated devices 5A and 5B can be changed so that the operator is notified that the operation has been completed by perceiving a changed feeling.

The processes of step S3B and step S4 are executed by the main control device 9. Furthermore, the operation completion driving pattern used in step S3B may be stored in the memory 10 together with the table shown in FIG. 9 or may be stored separately from the table.

The main control device 9 determines whether the process according to the program for providing a service to the operator has ended (step S5). For example, when the touch-panel-equipped display device 100 according to the first embodiment is used in an ATM, the process of step S5 may be implemented by determining whether a program for dispensing cash or transferring cash has ended.

When the main control device 9 has determined that the program has not ended in step S5, the flow returns to step S1. The main control device 9 repeats the process starting from step S1.

Assuming that it is determined that the pressing force is less than a predetermined threshold in step S2, a standing wave is generated by executing step S3A and step S4, the flow returns to step S1 from step S5, and then if it is determined in step S2 that the pressing force is greater than or equal to the predetermined threshold, the flow proceeds to step S3B and step S4. Accordingly, the oscillation on the surface substrate 4 changes from an oscillation according to a standing wave to an oscillation according to a pattern for notifying that the operation has been completed.

This flow is performed in a case where the operator first lightly touches the GUI button 23 and then increases the pressing force on the GUI button 23 in order to complete the operation.

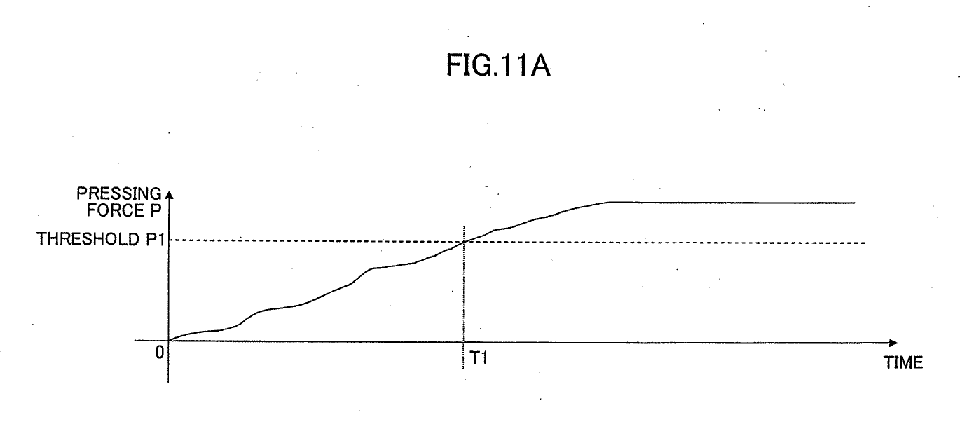

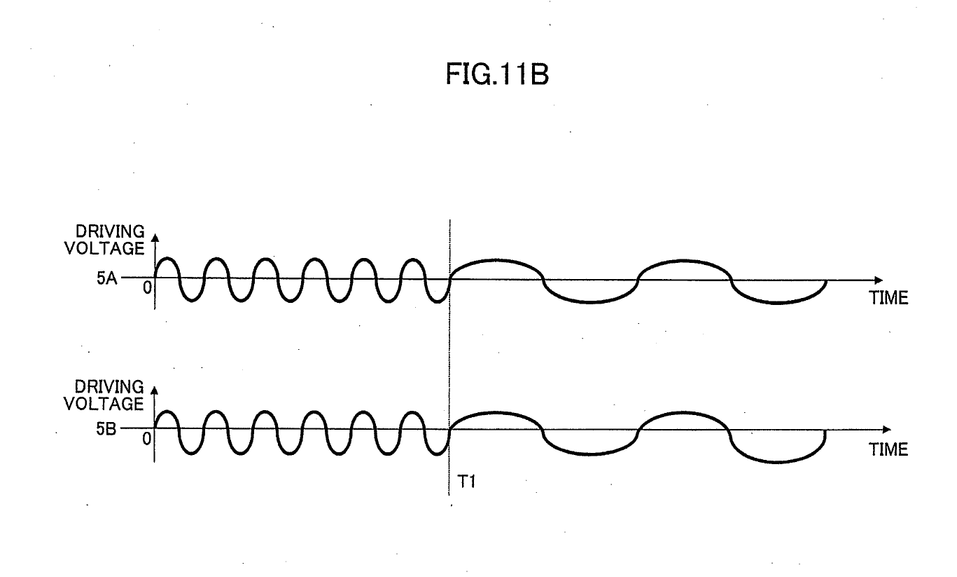

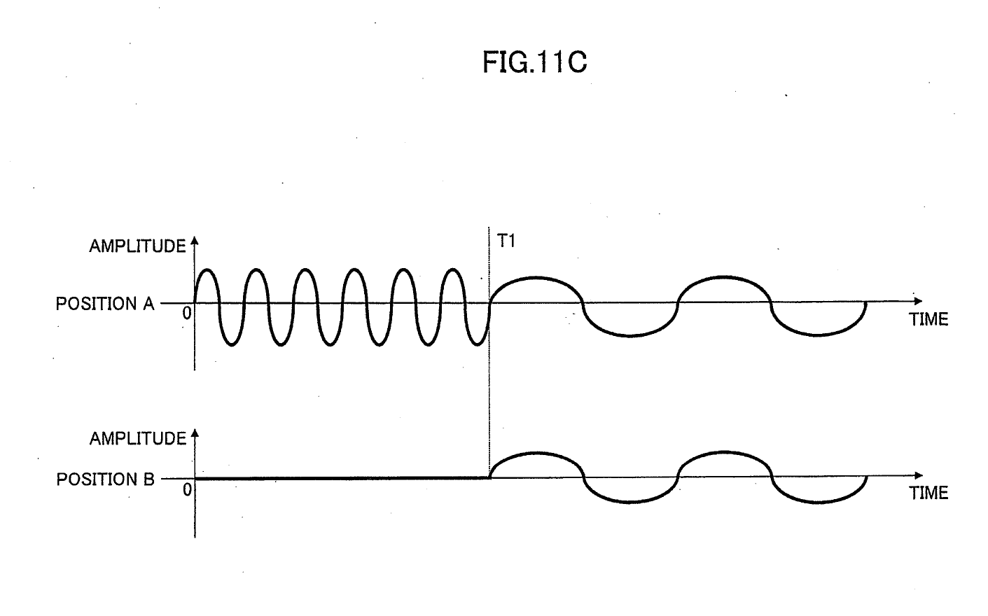

Accordingly, as the operator starts touching the surface substrate 4, the operator can immediately recognize the position of the GUI button 23 only by feeling an oscillation caused by a standing wave. When the operator stops applying a pressing force, the operator can confirm that the operation has been completed based on the perceived feeling. Next, with reference to FIGS. 11A through 11C, a description is given of a change in the oscillation waveform when the pressing force is increased as the operator first lightly touches the GUI button 23 and then increases the pressing force on the GUI button 23 in order to complete the operation.

FIGS. 11A through 11C are property diagrams indicating the driving conditions when the operator first lightly touches the GUI button 23 and then increases the pressing force on the GUI button 23 in order to complete the operation, with the touch-panel-equipped display device 100 according to the first embodiment. FIG. 11A indicates the temporal changes in the pressing force. FIG. 11B indicates the comparison of the oscillation waveforms when the piezoelectrically-actuated devices 5A and 5B are driven according to a standing wave driving pattern and an operation completion driving pattern. FIG. 11C indicates the amplitude at a position A where an antinode is generated and the amplitude at a position B where a node is generated on the surface of the surface substrate 4, when a standing wave is generated. With reference to FIG. 5A, position A corresponds to one of the positions of X1, X2, and X3, and position B corresponds to one of the four positions situated between the positions of X1, X2, and X3.

As shown in FIG. 11A, the pressing force P gradually increases starting from a time point t=0. When the pressing force P is less than a threshold P1, the piezoelectrically-actuated devices 5A and 5B are driven according to a frequency, a phase difference (note that the phase difference is zero in FIG. 11B), and an amplitude for generating a standing wave. Accordingly, an oscillation is generated so that an antinode of a standing wave is generated at the position A. The amplitude at position B is zero because the node of the standing wave is generated at position B. According to the standing wave, the operator can immediately recognize the position of a GUI element based on only the perceived feeling.

At a time point t=t1, the pressing force P becomes greater than or equal to the threshold P1. Therefore, the frequency for driving the piezoelectrically-actuated devices 5A and 5B is changed. Accordingly, a standing wave is no longer generated on the surface substrate 4. Thus, as shown in FIG. 11C, the surface substrate 4 oscillates according to the same phase at position A and position B. This means that the entire surface substrate 4 is oscillating according to the same phase. As the oscillation pattern changes in the above-described manner, the operator can recognize that the input operation has been completed based on only the perceived feeling.

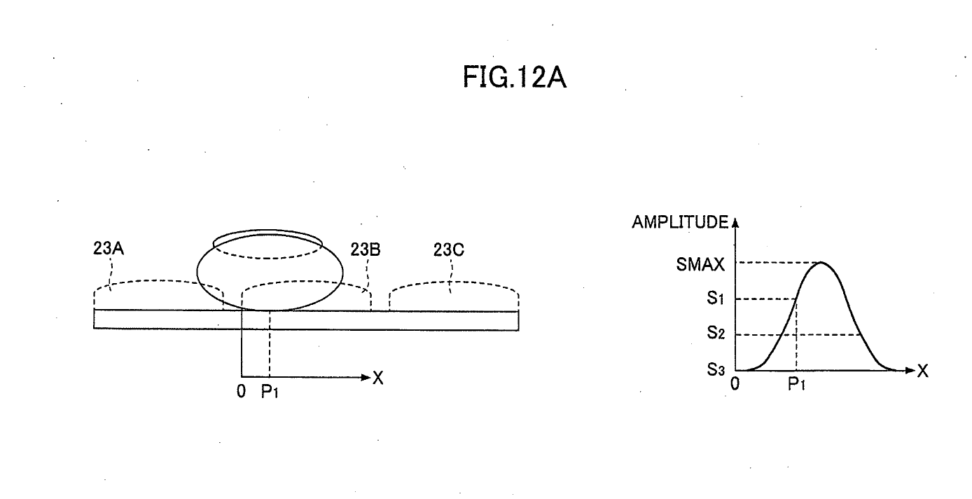

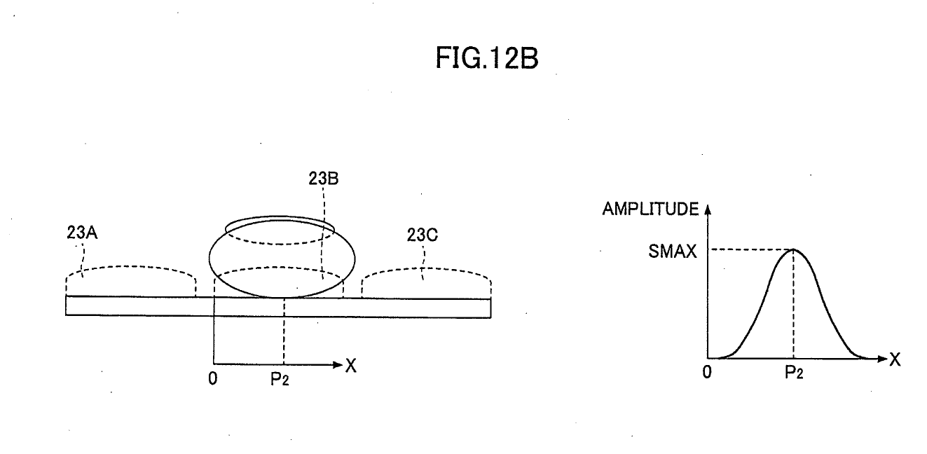

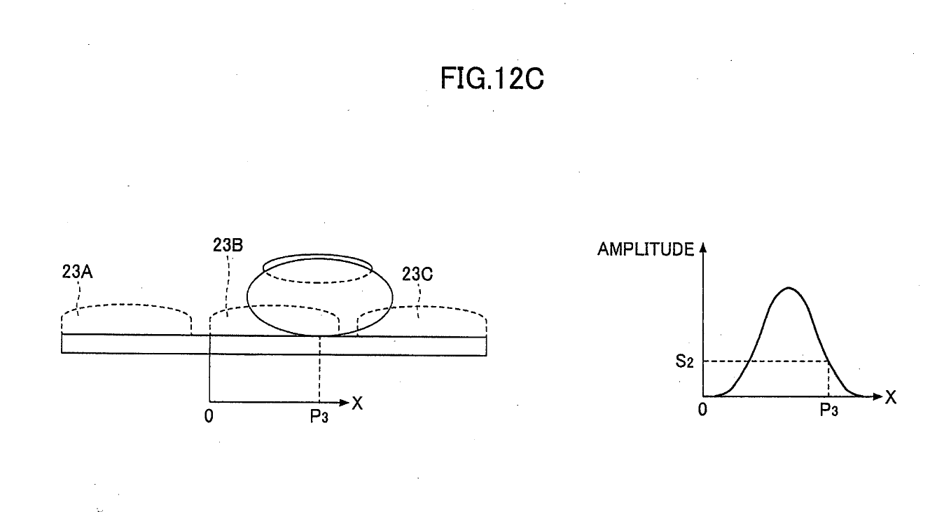

FIGS. 12A through 12C illustrate the relationship between the fingertip of the operator and the oscillation of the surface substrate 4, in another touch-panel-equipped display device as a matter of comparison (comparison example). In FIGS. 12A through 12C, the cross-sectional view on the left indicates the position of the operator's fingertip with respect to GUI buttons 23B on the coordinate input screen page, and the property diagram on the right indicates the relationship between the position of the fingertip in a width direction X of a GUI button 23B and the amplitude. FIGS. 12A through 12C illustrate that the operator is moving the position of his fingertip in an attempt to touch the GUI button 23B. The origin of the X axis corresponds to the left edge of the GUI button 23B.

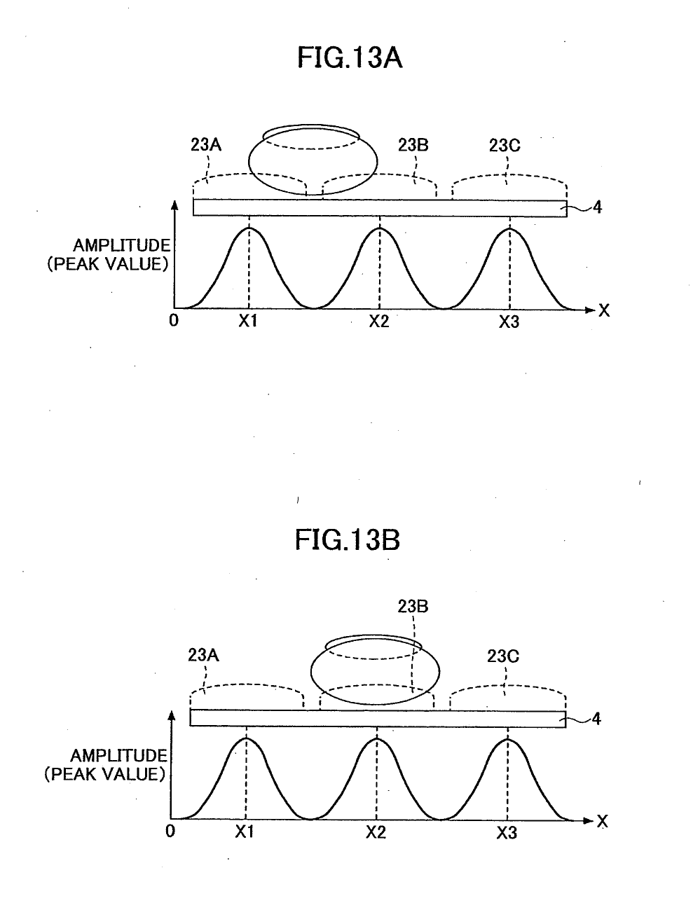

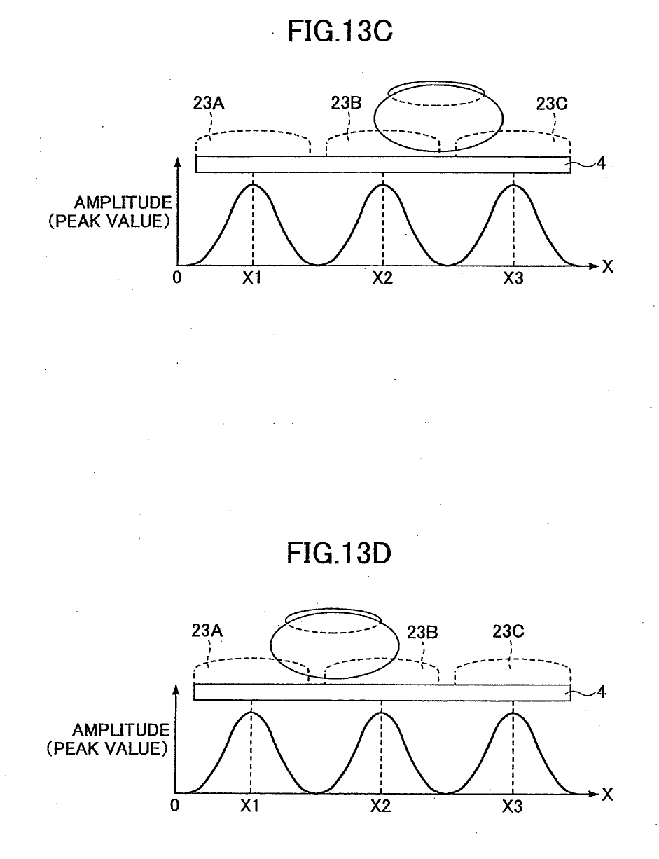

FIGS. 13A through 13D illustrate positional relationships between positions of the operator's fingertip and peak values of amplitudes of standing waves generated on the surface substrate 4, in the touch-panel-equipped display device 100 according to the first embodiment of the present invention. In FIGS. 13A through 13D, the cross-sectional view on the top indicates the position of the operator's fingertip with respect to GUI buttons 23A, 23B, and 23C on the coordinate input screen page, and a corresponding waveform diagram on the bottom indicates peak values of amplitudes of the standing wave. In FIGS. 13A through 13D, the horizontal axis X, which applies to both the top cross-sectional view on the top and the waveform diagram on the bottom, indicates the position in the width direction of the surface substrate 4.

In FIGS. 12A through 13D, it is assumed that the operator's finger touching the GUI button is extending in a direction from the front toward the back of the plane of the sheet on which the figures are depicted. Furthermore, in FIGS. 12A through 13D, as a matter of description, the GUI buttons 23A, 23B, and 23C are illustrated with dashed lines as if they are three-dimensional buttons for the purpose of indicating the positions of the buttons. However, the GUI buttons 23A, 23B, and 23C are actually the same as the GUI buttons 23 shown in FIG. 5A, which are displayed on the liquid crystal panel 2 as GUI elements.

The touch-panel-equipped display device according to the comparison example is different from the touch-panel-equipped display device 100 according to the first embodiment of the present invention in that a standing wave is not generated on the surface substrate 4, and the amplitude for oscillating the entire surface substrate 4 is changed depending on the position of the fingertip with respect to the position of the GUI button 23. Otherwise, the touch-panel-equipped display device according to the comparison example is the same as the touch-panel-equipped display device 100 according to the first embodiment of the present invention.

In the touch-panel-equipped display device according to the comparison example, when the fingertip is positioned at the center of any of the GUI buttons 23A, 23B, and 23C, the amplitude becomes maximum (SMAX); when the fingertip is positioned between any of the GUI buttons 23A, 23B, and 23C, the amplitude becomes minimum (S3).

Accordingly, as the operator attempts to recognize the position of the GUI button 23 based on only the perceived feeling when he moves his fingertip along the surface of the surface substrate 4, the oscillation of the surface substrate 4 increases, so that the operator can recognize that his fingertip is moving toward the center position of the GUI button 23. Conversely, if the oscillation of the surface substrate 4 decreases, the operator can recognize that his fingertip is moving toward the edge position of the GUI button 23.

In such a touch-panel-equipped display device according to the comparison example, as shown in the cross-sectional view on the left in FIG. 12A, when the center of the fingertip is located at a position P1 in the X direction of the GUI button 23B, the amplitude of the piezoelectrically-actuated devices 5A and 5B is set at an amplitude S1, as shown in the property diagram on the right in FIG. 12A. In the comparison example, the entire surface substrate 4 is oscillated at the amplitude S1.

Accordingly, the operator cannot immediately recognize the position of his fingertip with respect to the position of the GUI button 23B, based on only the perceived feeling. The only way the operator can recognize the position of the GUI button 23B is when he moves his fingertip left to right and the amplitude changes accordingly.

For example, when the operator moves his fingertip slightly to the right to a position P2 shown in FIG. 12B, the entire surface substrate 4 oscillates at the maximum amplitude Smax. Therefore, the operator can recognize (i.e., feel) that his fingertip has moved toward the center position of the GUI button 23B, compared to the state in FIG. 12A.

Furthermore, when the operator continues to move his fingertip to the right to a position P3 shown in FIG. 12C, the entire surface substrate 4 oscillates at the amplitude S2. Therefore, the operator can recognize that his fingertip has moved past the center position of the GUI button 23B.

However, in the touch-panel-equipped display device according to the comparison example, when the fingertip of the operator touches the surface of the surface substrate 4, the entire surface substrate 4 oscillates at the same amplitude. Therefore, unless the operator moves his fingertip to the left and right, he cannot recognize the positional relationship between his fingertip and the GUI button 23B. Accordingly, the operator cannot immediately (as soon as he touches the surface substrate 4) recognize the positional relationship based on only the perceived feeling.

For example, when plural GUI buttons 23A, 23B, and 23C are arranged as shown in FIGS. 12A through 12C, in order to recognize whether the operator's fingertip is closer to the GUI button 23A, the GUI button 23B, or the GUI button 23C based on only the perceived feeling, the operator needs to move his fingertip left to right. Thus, there have been unresolved problems in terms of operability with the comparison example.

Furthermore, when the size of the GUI button 23B is so small that it is hidden by the fingertip, it is difficult to visually recognize the relative positions of the GUI button 23B and the fingertip.

One approach is to provide another type of touch-panel-equipped display device having a function of enlarging the GUI button positioned under the fingertip. However, when one of the GUI buttons is enlarged, the GUI buttons adjacent to the enlarged GUI button are hidden. Furthermore, the degree of freedom in the display declines according to the area used for enlarging the GUI button.

Meanwhile, in the touch-panel-equipped display device 100 according to the first embodiment of the present invention, when the fingertip is positioned between the GUI buttons 23A and 23B (in the middle of X1 and X2) as shown in FIG. 13A, the fingertip of the operator is touching the node of the standing wave. Therefore, no oscillation is transmitted to the fingertip of the operator. Thus, the operator can immediately recognize that his fingertip is positioned between the GUI buttons 23A and 23B, based on only the perceived feeling.

Furthermore, when the fingertip is positioned at the center position (position of X2) of the GUI button 23B as shown in FIG. 13B, the fingertip of the operator is touching the antinode of the standing wave, and therefore the strongest oscillation is transmitted to the fingertip of the operator. Therefore, the operator can immediately recognize that his fingertip is positioned at the center position of the GUI button 23B, based on only the perceived feeling.

Furthermore, when the fingertip is positioned between the GUI buttons 23B and 23C and closer to the GUI button 23B as shown in FIG. 13C, an antinode of the standing wave is positioned on the left side of the fingertip of the operator. The operator can feel a strong oscillation on the left side of his fingertip. Therefore, the operator can immediately recognize that his fingertip is between the GUI buttons 23B and 23C and closer to the GUI button 23B, based on only the perceived feeling.

Furthermore, when the fingertip is positioned between the GUI buttons 23A and 23B and closer to the GUI button 23B as shown in FIG. 13D, an antinode of the standing wave is positioned on the right side of the fingertip of the operator. The operator can feel a strong oscillation on the right side of his fingertip. Therefore, the operator can immediately recognize that his fingertip is between the GUI buttons 23A and 23B and closer to the GUI button 23B, based on only the perceived feeling.

As described above, with the touch panel device and the touch-panel-equipped display device 100 according to the first embodiment of the present invention, when the operator touches the surface of the surface substrate 4 with his fingertip, the operator can perceive the feeling of a generated standing wave at the position of the GUI button 23. Therefore, the operator can immediately recognize the positional relationship between his fingertip and the GUI element, based on only the perceived feeling. Accordingly, a touch panel device and a touch-panel-equipped display device having excellent operability can be provided.

When there are many GUI elements, the size of each GUI button may be small, and may be hidden by the operator's fingertip. However, in the touch panel device and a touch-panel-equipped display device according to the first embodiment of the present invention, the operator can immediately recognize the position of a GUI button based on only the perceived feeling. Therefore, operation errors may be prevented such that the physical and mental workload on the operator can be reduced, thereby significantly improving usability.

Furthermore, when the pressing force on the surface substrate 4 becomes greater than or equal to a predetermined threshold, the driving pattern applied to the piezoelectrically-actuated devices 5A and 5B is changed. Therefore, the operator can recognize that the input operation has been recognized by the device (operation completed). Accordingly, in addition to the effect that the operator can immediately recognize the position of the GUI by the perceived feeling, the operator can also be notified that the operation has been completed by perceiving the changed feeling, thereby further improving convenience.

In the above description, the surface substrate 4 is oscillated such that the antinodes or nodes of the standing wave are positioned at the center positions or the boundaries of the GUI elements. However, the positions of the antinodes or nodes of the standing wave are not so limited, as long as the standing wave is generated in accordance with positions of the GUI elements such that the positions of the GUI elements can be recognized by the operator.

When the waveform generated at the piezoelectrically-actuated devices 5A and 5B is reflected at the edge portions of the surface substrate 4, the waveform of the standing wave may become deformed. However, this can be prevented as follows. Specifically, the frequency and the phase difference of the piezoelectrically-actuated devices 5A and 5B may be adjusted, or an oscillation absorption member may be disposed at the edge portions of the surface substrate 4.

### Second Embodiment

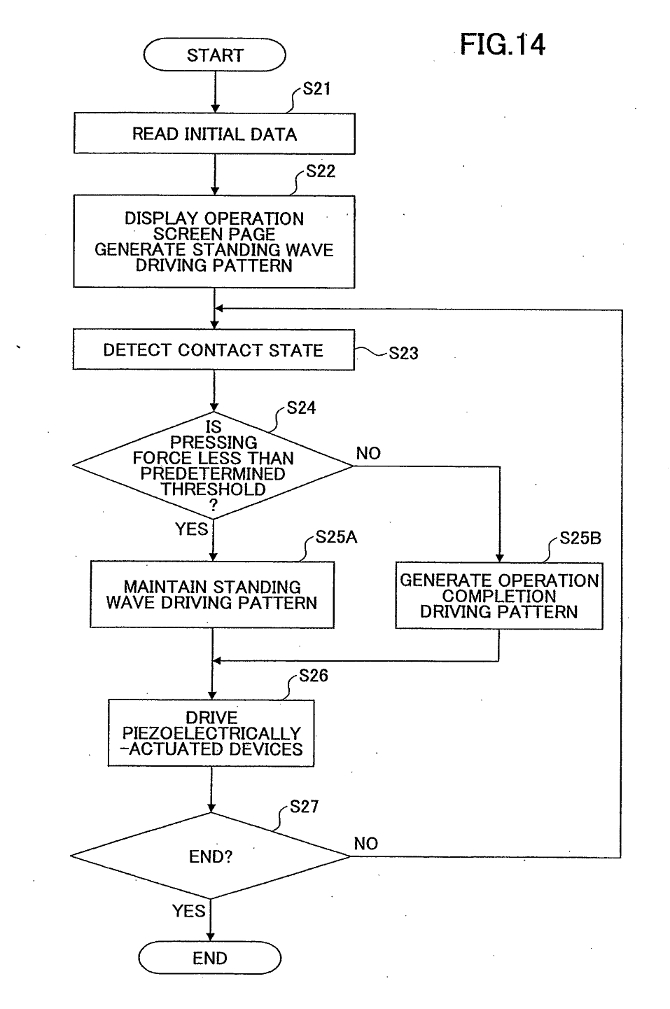

FIG. 14 is a flowchart of a process of generating a driving pattern executed by the main control device 9 of a touch-panel-equipped display device according to a second embodiment of the present invention. The process corresponds to a method of controlling the touch panel device according to the second embodiment.

The touch-panel-equipped display device according to the second embodiment is different from the touch-panel-equipped display device 100 according to the first embodiment in that a standing wave is generated on the surface substrate 4 immediately after it is activated. Accordingly, reference is made to the configuration shown in FIG. 1, and aspects in the process that are different from the first embodiment are mainly described below.

When the touch-panel-equipped display device according to the second embodiment is activated, the main control device 9 starts the process shown in FIG. 14 (START).

In order to activate the touch-panel-equipped display device according to the second embodiment, a predetermined operation screen page needs to be displayed on the liquid crystal panel 2. Thus, when the touch-panel-equipped display device is activated, the main control device 9 uses the image pattern ID of each image pattern of a corresponding GUI element to be displayed on the initial operation screen page, to read the data from the table shown in FIG. 9 used as initial data. The data that is read from the table includes image data IDs, display coordinate data, frequency data, amplitude data, and phase difference data (step S21).

Next, the main control device 9 inputs, in the image display circuit 7, the image data and the display coordinate data associated with the image data IDs, as image patterns. Furthermore, the main control device 9 inputs, in the drive control circuit 8, a driving pattern (standing wave driving pattern) expressed by frequency data, amplitude data, and phase difference data for generating a standing wave (step S22).

Accordingly, when the initial operation screen page is displayed, antinodes of a standing wave are generated at center positions of buttons corresponding to GUI elements. That is, as shown in FIG. 5A, a standing wave is generated, in which the antinodes are positioned at the GUI buttons 23.

Therefore, by touching the GUI buttons 23, the operator can recognize the boundaries 232 of the GUI buttons 23 based on the oscillation of the standing wave. Therefore, when the operator touches the coordinate input screen page (surface of the surface substrate 4), the operator can immediately recognize the positions of the GUI buttons 23 based on only the perceived feeling.

Next, the main control device 9 detects the contact state on the coordinate input screen page (surface of the surface substrate 4) (step S23). The contact state is detected by detecting input coordinate information that is input from the contact sensor process circuit 6.

Next, the main control device 9 determines whether the pressing force on the coordinate input screen page (surface of the surface substrate 4) is less than a predetermined threshold (step S24). The determination of the pressing force is performed based on a voltage value expressing area information that is input from the contact sensor process circuit 6.

When the main control device 9 determines that the pressing force is less than a predetermined threshold in step S24, the main control device 9 maintains the driving pattern (standing wave driving pattern) expressed by the frequency data, amplitude data, and phase difference data read from the memory 10 in step S22 (step S25A).

Next, the main control device 9 inputs, in the drive control circuit 8, the driving pattern maintained in step S25A, and drives the piezoelectrically-actuated devices 5A and 5B (step S26).

In this case, the main control device 9 continues to input the driving pattern read in step S22 to the drive control circuit 8, and therefore, the same standing wave as that generated in step S22 is maintained on the surface substrate 4.

This is because if the pressing force is less than the predetermined threshold, it is assumed that the operator has not completed inputting an operation.

Conversely, when the main control device 9 determines that the pressing force is greater than or equal to the predetermined threshold in step S24, the main control device 9 changes the driving pattern. Specifically, the main control device 9 reads, from the memory 10, a driving pattern (operation completion driving pattern) for generating an oscillation for the GUI button 23, so that the operator is notified that the operation has been completed based on the perceived feeling (step S25B).

Next, in step S26, the driving pattern (operation completion driving pattern) obtained as a result of changing the driving pattern in step S25B is input to the drive control circuit 8 to drive the piezoelectrically-actuated devices 5A and 5B.

The operation completion driving pattern may be any pattern as long as the frequency, the phase difference, or the amplitude for driving the piezoelectrically-actuated devices 5A and 5B can be changed so that the operator is notified that the operation has been completed by perceiving a changed feeling.

The main control device 9 determines whether the process according to the program for providing a service to the operator has ended (step S27).

When the main control device 9 has determined that the program has not ended in step S27, the flow returns to step S21. The main control device 9 repeats the process starting from step S21.

With the touch panel device and the touch-panel-equipped display device according to the second embodiment of the present invention, the standing wave is generated on the surface substrate 4 immediately after the device is activated, and therefore, when the operator touches the surface of the surface substrate 4 with his fingertip, the operator can immediately recognize the positional relationship between his fingertip and the GUI element based on only the perceived feeling. Accordingly, a touch panel device and a touch-panel-equipped display device having excellent operability can be provided.

Furthermore, when the pressing force on the surface substrate 4 becomes greater than or equal to a predetermined threshold, the driving pattern applied to the piezoelectrically-actuated devices 5A and 5B is changed. Therefore, the operator can recognize that the input operation has been recognized by the device (operation completed). Accordingly, in addition to the effect that the operator can immediately recognize the position of the GUI by the perceived feeling, the operator can also be notified that the operation has been completed by perceiving the changed feeling, thereby further improving convenience.

### Third Embodiment

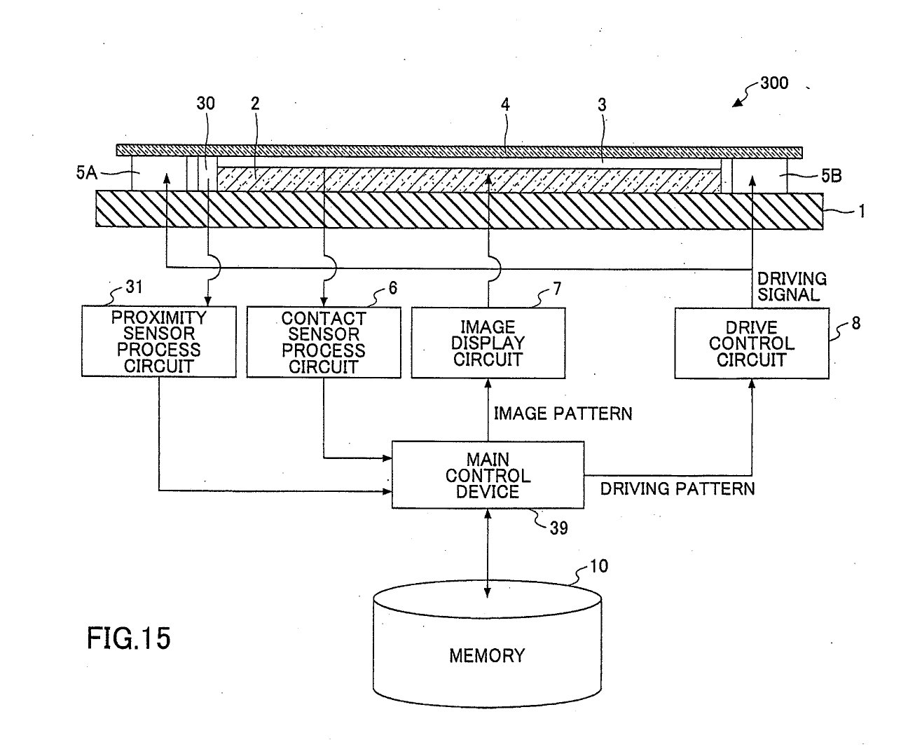

FIG. 15 is a cross-sectional view of a touch-panel-equipped display device according to a third embodiment of the present invention.

A touch-panel-equipped display device 300 according to the third embodiment includes the base substrate 1, the liquid crystal panel 2, the contact sensor 3, the surface substrate 4, the piezoelectrically-actuated devices 5A and 5B, the contact sensor process circuit 6, the image display circuit 7, the drive control circuit 8, a main control device 39, and the memory 10. Furthermore, the touch-panel-equipped display device 300 is provided with a proximity sensor 30 and a proximity sensor process circuit 31, which are not included in the touch-panel-equipped display device 100 according to the first embodiment.

The proximity sensor 30 is located between the base substrate 1 and the surface substrate 4 at a position that does not block the liquid crystal panel 2 or the contact sensor 3, and serves as a proximity degree detecting unit for detecting the proximity (degree of proximity) of the operator. The proximity sensor 30 may be any kind of sensor as long as it can detect that the operator has approached (has come near) the touch-panel-equipped display device 300 according to the third embodiment. As long as the proximity sensor 30 can detect the distance between the operator and the touch-panel-equipped display device 300, the proximity sensor 30 may be any of the following examples. One example is a sonar type sensor for emitting sound waves and detecting sound waves reflected from the fingertip of the operator. Another example is a sensor for emitting supersonic waves, light beams, or electromagnetic waves to detect a reflective wave that is reflected from the fingertip of the operator. Yet another example is an infrared sensor for detecting heat emitted by the operator. Yet another example is a capacitance type sensor for detecting the change in the electric capacitance caused when the operator fingertip approaches the touch-panel-equipped display device 300. When a capacitance type sensor is used as the contact sensor 3, there is no need to provide the proximity sensor 30, because the contact sensor 3 can also serve as a capacitance type proximity sensor.

When the proximity sensor 30 detects that an operator has approached the touch-panel-equipped display device 300, the proximity sensor 30 outputs a voltage value expressing proximity information. The voltage value expressing proximity information is configured to increase as the operator comes closer to the touch-panel-equipped display device 300.

The proximity sensor process circuit 31 converts the proximity information input from the proximity sensor 30 into digital data, and inputs the digital data into the main control device 39.

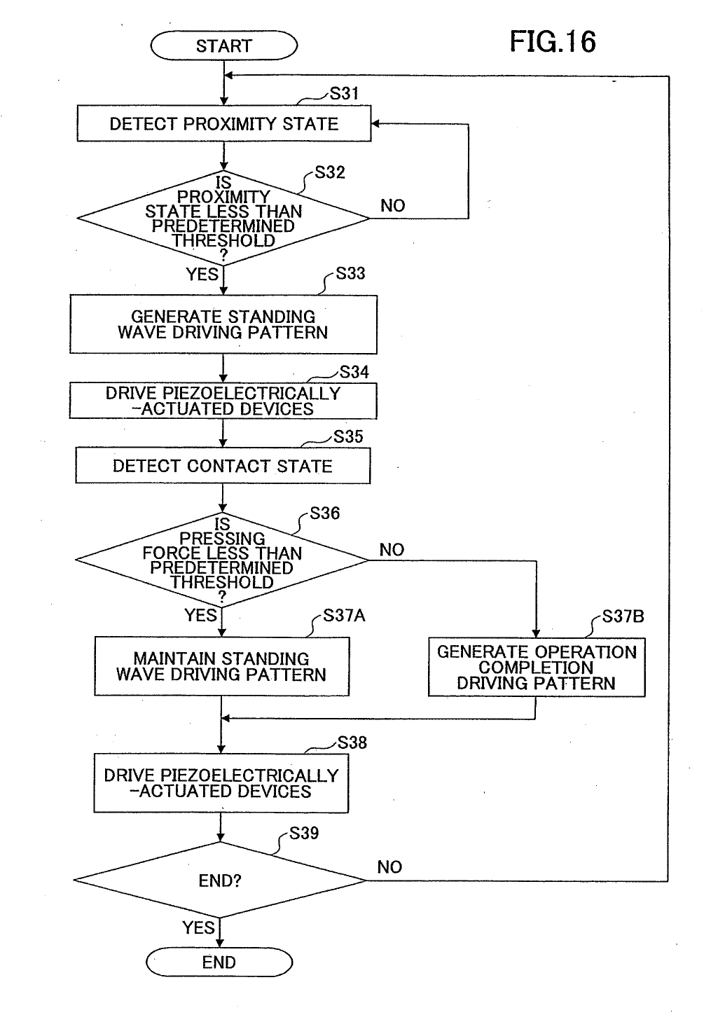

Next, with reference to the flowchart of FIG. 16, a description is given of a process of generating a driving pattern executed by the main control device 39 of the touch-panel-equipped display device 300 according to the third embodiment.

FIG. 16 is a flowchart of a process of generating a driving pattern executed by the main control device 39 of the touch-panel-equipped display device 300 according to the third embodiment. The process corresponds to a method of controlling the touch panel device according to the third embodiment.

When the touch-panel-equipped display device 300 according to the third embodiment is activated, the main control device 39 starts the process shown in FIG. 16 (START).

The touch-panel-equipped display device 300 according to the third embodiment initially displays a predetermined initial operation screen page on the liquid crystal panel 2.

When the touch-panel-equipped display device 300 is activated, the main control device 39 uses the image pattern ID of each GUI element to be displayed on the initial operation screen page to read the corresponding image data ID, display coordinate data, frequency data, amplitude data, and phase difference data from the table shown in FIG. 9. Then, the main control device 39 inputs the image data and display coordinate data associated with the image data ID in the image display circuit 7. Accordingly, the initial operation screen page is displayed on the liquid crystal panel 2.

As described above, at the initial stage, the touch-panel-equipped display device 300 according to the third embodiment is displaying the initial operation screen page on the liquid crystal panel 2, but, the piezoelectrically-actuated devices 5A and 5B are not yet driven, and a standing wave is not yet generated on the surface substrate 4.

First, the main control device 39 detects a proximity state with respect to the coordinate input screen page (surface of the surface substrate 4) (step S31). The proximity state (how close the operator is) is detected by detecting proximity information that is input from the proximity sensor process circuit 31.

Next, the main control device 39 determines whether the proximity is greater than or equal to a predetermined threshold (step S32). The main control device 39 serves as a proximity determining unit, for determining whether the voltage value expressing proximity information is greater than or equal to a predetermined voltage threshold. When the voltage value is less than the predetermined voltage threshold, the operator is still away from the surface of the surface substrate 4. When the voltage value is greater than or equal to the predetermined voltage threshold, the operator has come very near the surface of the surface substrate 4. The process of step S32 is repeated until the voltage value expressing the proximity information is determined as being greater than or equal to the predetermined voltage threshold.

When the main control device 39 determines that the voltage value expressing proximity information is greater than or equal to the predetermined voltage threshold in step S32, the main control device 39 generates a driving pattern (standing wave driving pattern) with the use of the frequency data, the amplitude data, and the phase difference data that is read from the memory 10 in advance when the touch-panel-equipped display device 300 is activated (step S33).

The process in step S33 is performed by the frequency control circuit 14, the phase control circuit 15, and the amplitude control circuit 16 in the standing wave generating circuit 13 shown in FIG. 4.

Next, the main control device 39 inputs, in the drive control circuit 8, the driving pattern (standing wave driving pattern) expressed by the frequency data, the amplitude data, and the phase difference data for generating a standing wave, and drives the piezoelectrically-actuated devices 5A and 5B (step S34).

Then, the main control device 39 detects a contact state on the coordinate input screen page (surface of the surface substrate 4) (step S35). The contact state is detected by detecting input coordinate information that is input from the contact sensor process circuit 6.

Next, the main control device 39 determines whether the pressing force on the coordinate input screen page (surface of the surface substrate 4) is less than a predetermined threshold (step S36). The pressing force is determined based on a voltage value expressing area information that is input from the contact sensor process circuit 6.

Steps S35 and S36 are executed by the contact status determination circuit 11 included in the main control device 39.

When the main control device 39 determines that the pressing force is less than a predetermined threshold in step S36, the main control device 39 maintains the standing wave driving pattern generated in step S34 (step S37A).

Next, the main control device 39 inputs, in the drive control circuit 8, the driving pattern (standing wave driving pattern) maintained in step S37A, and drives the piezoelectrically-actuated devices 5A and 5B (step S38).

In this case, the main control device 39 continues to input the same standing wave driving pattern as that input in step S34, and therefore the same standing wave as that generated in step S34 is maintained on the surface substrate 4.

This is because if the pressing force is less than the predetermined threshold, it is assumed that the operator has not completed inputting an operation.

Step S37A is executed by the frequency control circuit 14, the phase control circuit 15, and the amplitude control circuit 16 in the standing wave generating circuit 13 shown in FIG. 4.

Conversely, when the main control device 39 determines that the pressing force is greater than or equal to the predetermined threshold in step S36, the main control device 39 reads, from the memory 10, a driving pattern (operation completion driving pattern) for generating an oscillation for the GUI button 23, so that the operator is notified that the operation has been completed based on the perceived feeling (step S37B).

Next, in step S38, the main control device 39 inputs the driving pattern (operation completion driving pattern) generated in step S37B to the drive control circuit 8, and drives the piezoelectrically-actuated devices 5A and 5B.

The operation completion driving pattern may be any pattern as long as the frequency, the phase difference, or the amplitude for driving the piezoelectrically-actuated devices 5A and 5B can be changed so that the operator is notified that the operation has been completed by perceiving a changed feeling.

The processes of step S37B and step S38 are executed by the main control device 39. Furthermore, the operation completion driving pattern used in step S37B may be stored in the memory 10 together with the table shown in FIG. 9 or may be stored separately from the table.

The main control device 39 determines whether the process according to the program for providing a service to the operator has ended (step S39). For example, when the touch-panel-equipped display device 300 according to the third embodiment is used in an ATM, the process of step S39 may be implemented by determining whether a program for dispensing cash or transferring cash has ended.

When the main control device 39 has determined that the program has not ended in step S39, the flow returns to step S31. The main control device 39 repeats the process starting from step S31.

Assuming that it is determined that the pressing force is less than a predetermined threshold in step S36, a standing wave is generated by executing step S37A and step S38, the flow returns to step S31 from step S39, and then it is determined in step S36 that the pressing force is greater than or equal to the predetermined threshold, the flow proceeds to step S37B and step S38. Accordingly, the oscillation on the surface substrate 4 changes from an oscillation according to a standing wave to an oscillation according to a pattern for notifying that the operation has been completed.

This flow is performed in a case where the operator first lightly touches the GUI button 23 and then increases the pressing force on the GUI button 23 in order to complete the operation.

Accordingly, as the operator starts touching the surface substrate 4, the operator can immediately recognize the position of the GUI button 23 only by feeling an oscillation caused by a standing wave. When the operator stops applying a pressing force, the operator can confirm that the operation has been completed by the perceived feeling.

With the touch panel device and the touch-panel-equipped display device 300 according to the third embodiment of the present invention, immediately before the operator touches the surface of the surface substrate 4, a proximity state is detected and a process of generating a standing wave on the surface substrate 4 is executed in advance. Therefore, even if the processing speed of the main control device 39 is not sufficiently high, by the time the operator touches the surface substrate 4, the surface substrate 4 will be oscillating according to the standing wave. Accordingly, when the operator touches the surface of the surface substrate 4, the operator can immediately recognize the positional relationship between his fingertip and a GUI element without a time-lag, based on only the perceived feeling. Accordingly, a touch panel device and a touch-panel-equipped display device having excellent operability can be provided.

Furthermore, generation of the standing wave starts when the operator approaches the surface substrate 4, and therefore power consumption can be reduced.

In the above description, the proximity state of the operator is determined based on the distance; however, the proximity state may be determined based on the speed or the speed of acceleration at which the operator approaches the surface substrate 4.

### Fourth Embodiment

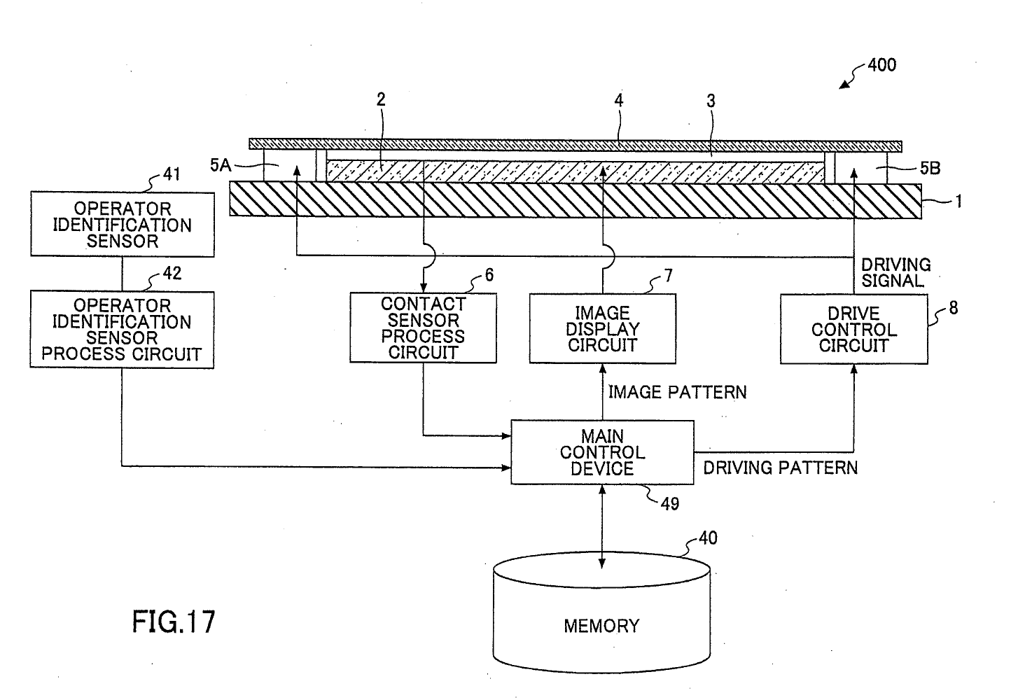

FIG. 17 is a cross-sectional view of a touch-panel-equipped display device according to a fourth embodiment of the present invention.

A touch-panel-equipped display device 400 according to the fourth embodiment includes the base substrate 1, the liquid crystal panel 2, the contact sensor 3, the surface substrate 4, the piezoelectrically-actuated devices 5A and 5B, the contact sensor process circuit 6, the image display circuit 7, the drive control circuit 8, a main control device 49, and a memory 40. Furthermore, the touch-panel-equipped display device 400 is provided with an operator identification sensor 41 and an operator identification sensor process circuit 42, which are not included in the touch-panel-equipped display device 100 according to the first embodiment.

The touch-panel-equipped display device 400 according to the fourth embodiment reads an operator ID held by the operator, and changes the driving pattern for the piezoelectrically-actuated devices 5A and 5B accordingly.

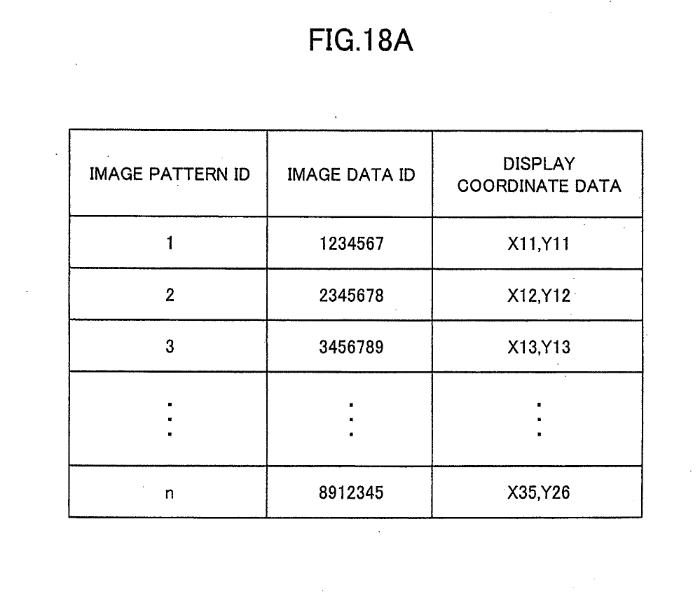

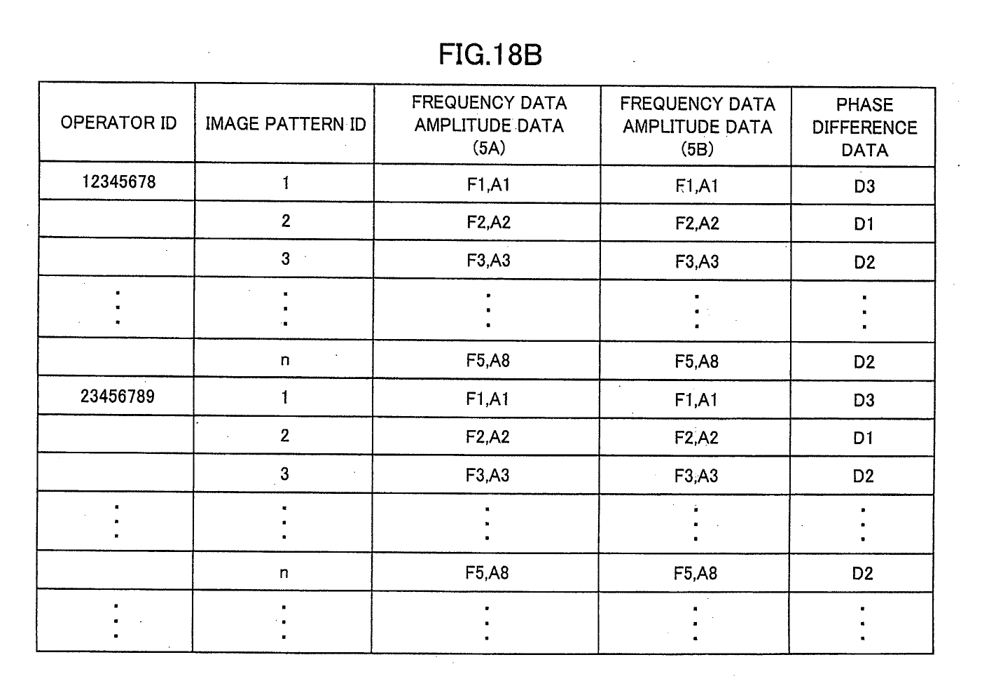

Thus, the memory 40 stores a table in which the operator IDs held by operators are associated with driving patterns. The structure of the table is described below with reference to FIGS. 18A and 18B.

The operator identification sensor 41 is an identification information reading unit for reading an identification tag held by the operator. The identification tag held by the operator may be, for example, an RF-ID tag. In the fourth embodiment, the operator ID is stored in an RF-ID tag, and the operator identification sensor 41 reads the operator ID (operator identifier) from an RF-ID tag held by the operator, and outputs identification information expressing the operator ID.

The operator identification sensor process circuit 42 converts identification information input from the operator identification sensor 41 into identifier data, and inputs the identifier data in the main control device 49. The identifier data expresses the operator ID.

In the fourth embodiment, the main control device 49 functions as a driving pattern reading unit for reading a driving pattern associated with an operator ID from the memory 40. The main control device 49 controls the operation of driving and controlling the piezoelectrically-actuated devices 5A and 5B with the use of the driving pattern read from the memory 40.

FIGS. 18A and 18B illustrate examples of tables stored in the memory 40 of the touch-panel-equipped display device 400 according to the fourth embodiment.

The memory 40 stores a first table in which image pattern IDs, image data IDs, and display coordinate data are associated with each other as shown in FIG. 18A, and a second table in which operator IDs, image pattern IDs, frequency data, amplitude data, and phase difference data are associated with each other as shown in FIG. 18B.

An operator ID is for identifying the operator, which may be assigned to each operator, or to a group of operators that are grouped together according to gender or age or some other characteristic so that each operator holds an ID of a particular group.

The image pattern ID, the image data ID, the display coordinate data, the frequency data, the amplitude data, and the phase difference data are the same as those of the first embodiment, and are thus not further described.

The touch-panel-equipped display device 400 according to the fourth embodiment includes two tables as shown in FIGS. 18A and 18B, i.e., the first table including image pattern IDs, image data IDs, and display coordinate data that are associated with each other, and the second table including image pattern IDs, frequency data, amplitude data, and phase difference data that is associated with operator IDs.

The first table includes image pattern IDs, image data IDs, and display coordinate data extracted from the table according to the first embodiment shown in FIG. 9. The second table includes sub-tables in which image pattern IDs, frequency data, amplitude data, and phase difference data extracted from the table according to the first embodiment shown in FIG. 9 is associated with operator IDs.

First, the main control device 49 uses an operator ID to read a sub-table corresponding to the operator ID from the second table stored in the memory 40. The sub-table includes an image pattern ID, frequency data, amplitude data, and phase difference data.

The main control device 49 uses the image pattern ID to read corresponding information including an image data ID and display coordinate data from the first table stored in the memory 40, and also to read the frequency data, the amplitude data, and the phase difference data from the sub-table.

The main control device 49 uses the image data ID, the display coordinate data, the frequency data, the amplitude data, and the phase difference data to display GUI elements on the liquid crystal panel 2 and to drive and control the piezoelectrically-actuated devices 5A and 5B.

In this example, the main control device 49 uses the image pattern ID to read the image data ID, the display coordinate data, the frequency data, the amplitude data, and the phase difference data. However, the method of reading the data is not so limited.

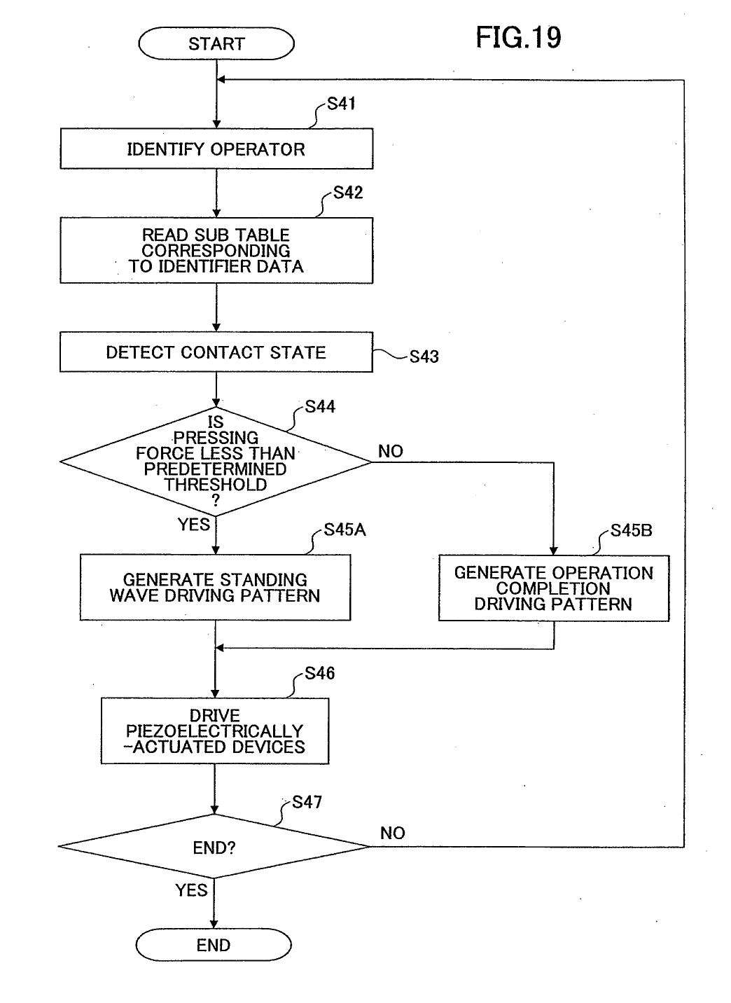

FIG. 19 is a flowchart of a process of generating a driving pattern executed by the main control device 49 of the touch-panel-equipped display device 400 according to the fourth embodiment of the present invention. The process corresponds to a method of controlling the touch panel device according to the fourth embodiment.

When the touch-panel-equipped display device 400 according to the fourth embodiment is activated, the main control device 49 starts the process shown in FIG. 19 (START).

The touch-panel-equipped display device 400 according to the fourth embodiment is in a standby state displaying a predetermined initial operation screen page on the liquid crystal panel 2.

The main control device 49 detects identifier data (step S41). The identifier data is input from the operator identification sensor process circuit 42.

Next, the main control device 49 uses the identifier data to read a sub-table corresponding to the identifier data from the table stored in the memory 40 (step S42).

Next, the main control device 49 detects the contact state on the coordinate input screen page (surface of the surface substrate 4) (step S43). The contact state is detected by detecting input coordinate information that is input from the contact sensor process circuit 6.

Next, the main control device 49 determines whether the pressing force on the coordinate input screen page (surface of the surface substrate 4) is less than a predetermined threshold (step S44). The determination of the pressing force is performed based on a voltage value expressing area information that is input from the contact sensor process circuit 6.

Steps S43 and S44 are executed by the contact status determination circuit 11 included in the main control device 49 as depicted in FIG. 3.

When the main control device 49 determines that the pressing force is less than a predetermined threshold in step S44, the main control device 49 reads the frequency data, the amplitude data, and the phase difference data that is associated with the image pattern ID from the sub-table read from the memory 40 in step S42, and generates a driving pattern (standing wave driving pattern) accordingly (step S45A).

After step S45A, the main control device 49 inputs, in the drive control circuit 8, the driving pattern (standing wave driving pattern) expressed by the frequency data, the amplitude data, and the phase difference data for generating a standing wave, and drives the piezoelectrically-actuated devices 5A and 5B (step S46).

Accordingly, oscillation is transferred to the surface substrate 4, and antinodes of the standing wave are generated at the center positions of the GUI element buttons. For example, as shown in FIG. 5A, antinodes of the generated standing wave are positioned at the GUI buttons 23.

Thus, when the operator touches the GUI button 23, the operator can recognize the position of the center position of the button based on the oscillation of the standing wave. Therefore, the operator can immediately recognize the position of the GUI button 23, based on only the feeling perceived by touching the coordinate input screen page (surface of the surface substrate 4).

As described above, when the pressing force is less than a predetermined threshold, a standing wave is generated on the surface substrate 4. This is because when the pressing force is less than a predetermined threshold, it is assumed that the operator is searching for the position of a target GUI button 23 in order to input an operation. Therefore, a standing wave is generated so that the operator can immediately recognize the position of the GUI button 23 based on only the feeling perceived by touching the surface substrate 4.

Conversely, when the main control device 49 determines that the pressing force is greater than or equal to the predetermined threshold in step S44, the main control device 49 reads, from the memory 40, a driving pattern (operation completion driving pattern) for generating an oscillation for the GUI button 23, so that the operator is notified that the operation has been completed based on the perceived feeling (step S45B).

After step S45B, in step S46, the main control device 49 inputs the driving pattern (operation completion driving pattern) read in step S45B to the drive control circuit 8, and drives the piezoelectrically-actuated devices 5A and 5B.

The operation completion driving pattern may be any pattern as long as the frequency of the standing wave can be changed so that the operator is notified that the operation has been completed by perceiving a changed feeling.

The main control device 49 determines whether the process according to the program for providing a service to the operator has ended (step S47). For example, when the touch-panel-equipped display device 400 according to the fourth embodiment is used in an ATM, the process of step S47 may be implemented by determining whether a program for dispensing cash or transferring cash has ended.

When the main control device 49 has determined that the program has not ended in step S47, the flow returns to step S41. The main control device 49 repeats the process starting from step S41.

With the touch panel device and the touch-panel-equipped display device 400 according to the fourth embodiment of the present invention, identifier data is read from an RF-ID tag held by an operator, and the piezoelectrically-actuated devices 5A and 5B are driven according to a driving pattern associated with the identifier data. Therefore, the intensity of the standing wave generated on the surface substrate 4 can be set according to attributes of the operator, such as gender and age and other characteristics.

Accordingly, optimum operability can be provided according to the operator.

For example, the sense of touch may differ according to age or individual differences. Typically, the sensitivity of touch deteriorates with age, and therefore a more intense standing wave needs to be generated for an elderly person to feel the same sense of touch as that of a young person.

Identifier data unique to each operator is used for storing data in advance in the second table in the memory 40 for each operator ID. Specifically, the stored data includes frequency data, amplitude data, and phase difference data, which is used for driving the piezoelectrically-actuated devices 5A and 5B. Thus, the intensity of the standing wave generated on the surface substrate 4 can be changed according to the operator. Therefore, optimum operability can be provided according to attributes of the operator such as age and individual differences. Accordingly, a touch panel device and a touch-panel-equipped display device having excellent operability can be provided.

The frequency data, the amplitude data, and the phase difference data may be set according to age or gender. Alternatively, the operator may manually set the data for himself in advance such that a maximum sense of touch and excellent operability can be attained.

In the above description, the standing wave driving pattern is changed. However, the operation completion driving pattern may also be changed in the same manner by changing the amplitude and the frequency according to identifier data.

### Fifth Embodiment

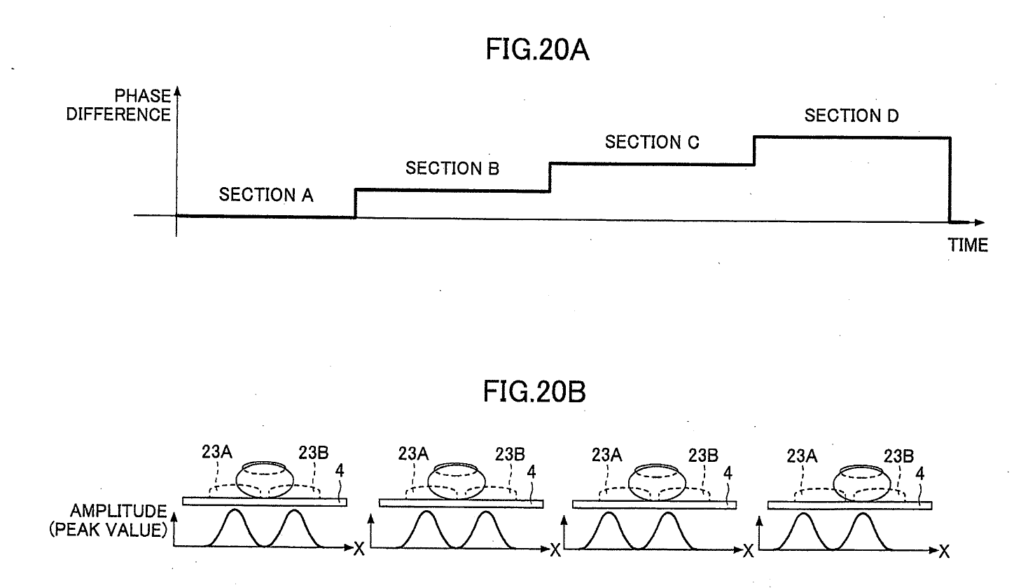

FIGS. 20A and 20B illustrate a driving pattern of a touch-panel-equipped display device according to a fifth embodiment of the present invention. FIG. 20A is a property diagram indicating temporal changes in the phase difference while driving the piezoelectrically-actuated devices 5A and 5B, and FIG. 20B indicates the relationship between the position of a standing wave in each section illustrated in FIG. 20A with respect to the fingertip.

The touch-panel-equipped display device according to the fifth embodiment is different from the touch-panel-equipped display device 100 according to the first embodiment in that the driving pattern of the standing wave is cyclically changed. Accordingly, reference is made to the configuration shown in FIG. 1, and aspects in the process that are different from the first embodiment are mainly described below.

FIG. 20A indicates sections A through D in the time period during which the piezoelectrically-actuated devices 5A and 5B are driven. In section A, the piezoelectrically-actuated devices 5A and 5B are driven at the same phase (zero phase difference). With the passage of time toward section D, the phase difference increases. Section D is followed by section A once again.

When the piezoelectrically-actuated devices 5A and 5B are driven at the same phase, a node of a standing wave is generated at a position of the fingertip (nodes are generated at intervals of 10 mm) and antinodes of the standing wave are generated on both sides of the fingertip.

For example, it is assumed that when the phase of the driving signals for the piezoelectrically-actuated devices 5A and 5B is changed by π/100, each antinode of the standing wave moves in the X direction to a position (section B) that is 0.1 mm apart from the position of section A.

In sections C and D, the phase is further changed by π/100 respectively, and therefore each antinode of the standing wave moves in the X direction to a position that is 0.1 mm apart from the position in the preceding section.

The touch-panel-equipped display device according to the fifth embodiment cyclically controls the phase difference between the piezoelectrically-actuated devices 5A and 5B, to cyclically change the positions of the antinodes and nodes of the standing wave.

In another example, the positions of the antinodes and nodes of the standing wave may be changed by storing data used for changing the driving pattern in the memory 10, and reading different phase difference data from the memory 10 in order to change the driving pattern. In yet another example, the positions of the antinodes and nodes of the standing wave may be changed by adjusting the phase difference in the phase control circuit 15.

In the above description, the phase difference is cyclically changed. However, in another example, the driving pattern may be cyclically changed by changing the frequency or the amplitude. The frequency or the amplitude may be changed by storing data used for changing the driving pattern in the memory 10, and reading a different frequency or amplitude that from the memory 10 in order to change the driving pattern. In another example, the frequency or the amplitude may be adjusted in the frequency control circuit 14 or the amplitude control circuit 16 of FIG. 4.

Furthermore, in the above description, the phase difference, the frequency, or the amplitude is cyclically changed by small amounts; however, in another example, the phase difference, the frequency, or the amplitude may be changed randomly instead of cyclically.

The pattern for driving the piezoelectrically-actuated devices 5A and 5B with the touch-panel-equipped display device according to the fifth embodiment may be any driving pattern as long as the positions of the antinodes and nodes of the standing wave or the amplitude or the frequency of the standing wave can be changed with the passage of time.

The operation of changing the driving pattern of the touch-panel-equipped display device according to the fifth embodiment is described above. The operation of changing the driving pattern in the above-described manner is particularly effective when the standing wave has a high frequency.

For example, if a high frequency is set for the standing wave, the frequency may be higher than a frequency that is perceivable by the tactile receptor of a human being. In such a case, pulsation like low-frequency pulses can be generated by slightly changing the phase difference, the frequency, or the amplitude.

If it is possible to generate a frequency of such a pulsation within the frequency range that is perceivable by the tactile receptor of a human being, the following effects can be achieved. That is, a touch panel device and a touch-panel-equipped display device can be provided, with which the operator can immediately recognize the position of a GUI element based on only the perceived feeling, even if the piezoelectrically-actuated devices 5A and 5B are driven at, a high frequency that cannot be perceived by the tactile receptor of a human being.

According to the fifth embodiment, a touch panel device and a touch-panel-equipped display device having excellent operability can be provided.

### Sixth Embodiment

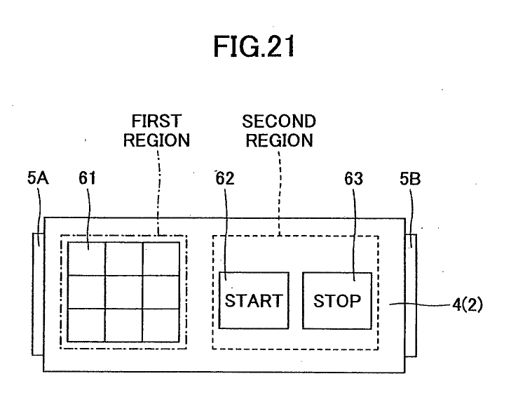

FIG. 21 is a top view of a coordinate input screen page of a touch-panel-equipped display device according to a sixth embodiment of the present invention.

The touch-panel-equipped display device according to the sixth embodiment is different from the touch-panel-equipped display device 100 according to the first embodiment in the following regard. That is, the touch-panel-equipped display device according to the sixth embodiment changes the driving pattern of the piezoelectrically-actuated devices 5A and 5B according to the position at which the operator has input an operation. Furthermore, even when GUI buttons of different sizes are displayed, the touch-panel-equipped display device according to the sixth embodiment generates a standing wave in accordance with the GUI button that is used for inputting the operation. Accordingly, reference is made to the configuration shown in FIG. 1, and aspects in the process that are different from the first embodiment are mainly described below.

The touch-panel-equipped display device according to the sixth embodiment displays GUI buttons 61, 62, and 63 on the coordinate input screen page (surface of the surface substrate 4).

The GUI buttons 61 include nine GUI buttons arranged in a matrix of 3 rows and 3 columns displayed in a first region in the coordinate input screen page. The GUI buttons 62 and 63 are a start button and a stop button, respectively, which are arranged in a second region in the coordinate input screen page.

The touch-panel-equipped display device according to the sixth embodiment generates standing waves of different pitches in the case where an operation is input in the first region and in the case where an operation is input in the second region. The standing waves of different pitches are generated by changing the driving pattern for the piezoelectrically-actuated devices 5A and 5B.

A first driving pattern is for generating a standing wave for the GUI buttons 61 in the first region. A second driving pattern is for generating a standing wave for the GUI buttons 62 and 63 in the second region. The data (frequency data, amplitude data, phase difference data) for the first and second driving patterns may be stored in separate tables in the memory 10. The tables may have the configuration shown in FIG. 9.

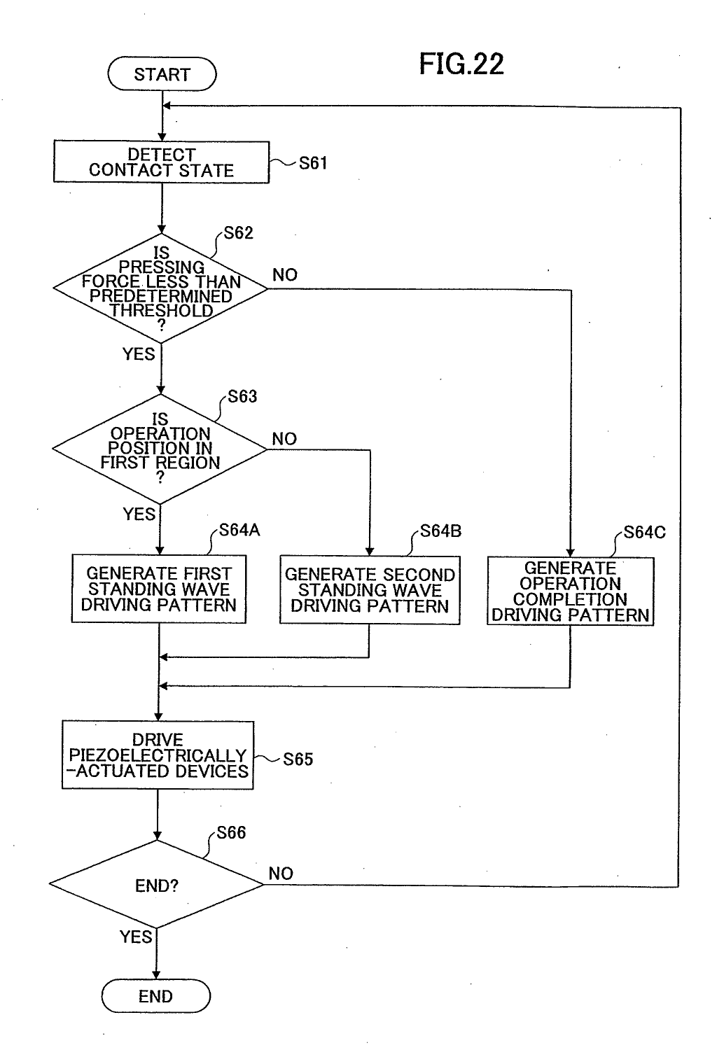

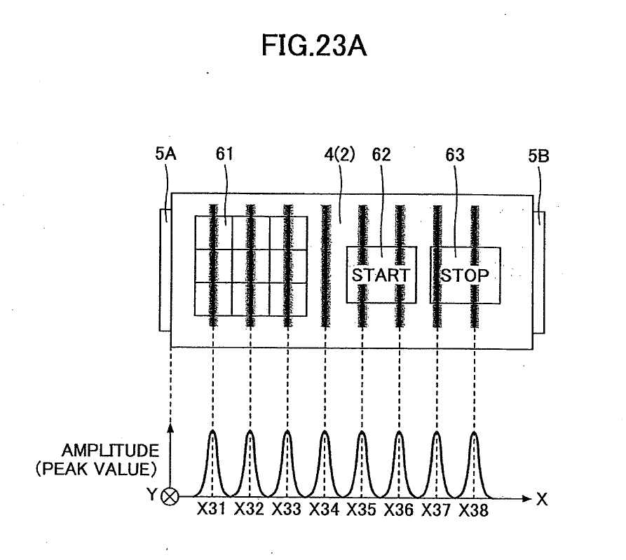

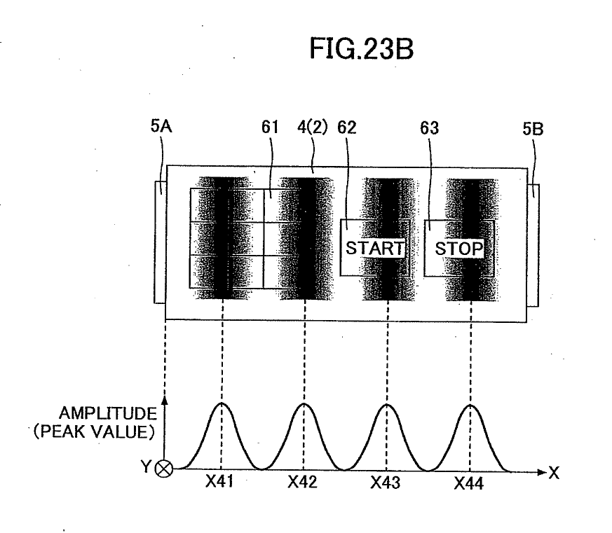

FIG. 22 is a flowchart of a process of generating a driving pattern executed by the main control device 9 of the touch-panel-equipped display device according to the sixth embodiment. The process corresponds to a method of controlling the touch panel device according to the sixth embodiment. Reference is made to FIGS. 23A and 23B in describing the process of FIG. 22.

FIGS. 23A and 23B illustrate displayed GUI elements that are visible through the surface substrate 4 of the touch-panel-equipped display device according to the sixth embodiment, and positional relationships between the GUI elements and the peak values of amplitudes of standing waves generated on the surface substrate 4. FIG. 23A illustrates a case where the generated standing wave is adjusted to the GUI buttons 61 in the first region. FIG. 23B illustrates a case where the generated standing wave is adjusted to the GUI buttons 62 and 63 in the second region.

When the touch-panel-equipped display device according to the sixth embodiment is activated, the main control device 9 starts the process shown in FIG. 22 (START).

The touch-panel-equipped display device according to the sixth embodiment initially displays a predetermined initial operation screen page on the liquid crystal panel 2.

When the touch-panel-equipped display device is activated, the main control device 9 uses the image pattern ID of each GUI element to be displayed on the initial operation screen page to read corresponding information including an image data ID, display coordinate data, frequency data, amplitude data, and phase difference data from the table shown in FIG. 9. Then, the main control device 9 inputs the image data and display coordinate data associated with the image data ID in the image display circuit 7. Accordingly, the initial operation screen page is displayed on the liquid crystal panel 2.

As described above, at the initial stage, the touch-panel-equipped display device according to the sixth embodiment is displaying the initial operation screen page on the liquid crystal panel 2, but the piezoelectrically-actuated devices 5A and 5B are not yet driven, and a standing wave is not yet generated on the surface substrate 4.

First, the main control device 9 detects a contact state on the coordinate input screen page (surface of the surface substrate 4) (step S61). The contact state is detected by detecting input coordinate information that is input from the contact sensor process circuit 6.

Next, the main control device 9 determines whether the pressing force on the coordinate input screen page (surface of the surface substrate 4) is less than a predetermined threshold (step S62). The determination of the pressing force is performed based on a voltage value expressing area information that is input from the contact sensor process circuit 6.

When the pressing force is low (not pressed or lightly pressed), the voltage value expressing area information is high. When the pressing force is high (strongly pressed), the voltage value expressing area information is low. Accordingly, the determination process in step S62 is actually performed by determining whether the voltage value expressing area information exceeds a predetermined voltage threshold.

The processes in step S61 and S62 are executed by the contact status determination circuit 11 included in the main control device 9.

When the main control device 9 determines that the pressing force is less than a predetermined threshold in step S62, the main control device 9 determines whether the operation position is within the first region (step S63). This determination is made for changing the driving pattern depending on whether the operation position is within the first region.

When the main control device 9 determines that the operation position is within the first region in step S63, the main control device 9 reads frequency data, amplitude data, and phase difference data from the memory 10 and generates a first driving pattern (first standing wave driving pattern) based on the read data (step S64A).

The process of step S64A is performed by the frequency control circuit 14, the phase control circuit 15, and the amplitude control circuit 16 in the standing wave generating circuit 13.

After step S64A, the main control device 9 inputs, in the drive control circuit 8, the first driving pattern (first standing wave driving pattern) expressed by the frequency data, the amplitude data, and the phase difference data for generating a standing wave, and drives the piezoelectrically-actuated devices 5A and 5B (step S65).

Accordingly, oscillation is transferred to the surface substrate 4, and antinodes of the standing wave are generated at the center positions of the GUI buttons 61 in the first region. As shown in FIG. 23A, antinodes of the generated standing wave are positioned at center positions of the GUI buttons 61. Antinodes of the standing wave are generated at the center positions of the GUI buttons 61 (positions corresponding to X31, X32, and X33), and also at positions corresponding to X34, X35, X36, X37, and X38. The positions of X34, X35, X36, X37, and X38 are in the second region; however, in the case where the flow proceeds to step S64A, the operator has input the operation in the first region, and therefore the operation is unaffected even if antinodes of the standing wave are positioned at X34, X35, X36, X37, and X38.

Thus, when the operator touches the GUI buttons 61, the operator can recognize the positions of the GUI buttons 61 from the oscillation of the standing wave. Therefore, the operator can immediately recognize the positions of the GUI buttons 61 in the first region, based on only the feeling perceived by touching the coordinate input screen page (surface of the surface substrate 4).

When the main control device 9 determines that the operation position is not within the first region in step S63, the main control device 9 reads frequency data, amplitude data, and phase difference data from the memory 10 and generates a second driving pattern (second standing wave driving pattern) based on the read data (step S64B).

The process of step S64B is performed by the frequency control circuit 14, the phase control circuit 15, and the amplitude control circuit 16 in the standing wave generating circuit 13 described in FIG. 4.

After step S64B, the main control device 9 inputs, in the drive control circuit 8, the second driving pattern (second standing wave driving pattern) expressed by the frequency data, the amplitude data, and the phase difference data for generating a standing wave, and drives the piezoelectrically-actuated devices 5A and 5B (step S65).

Accordingly, oscillation is transferred to the surface substrate 4, and antinodes of the standing wave are generated at the center positions of the GUI buttons 62 and 63 in the second region. As shown in FIG. 23B, antinodes of the generated standing wave are positioned at center positions of the GUI buttons 62 and 63. Antinodes of the standing wave are generated at the center positions of the GUI buttons 62 and 63 (positions corresponding to X43 and X44), and also at positions corresponding to X41 and X42. The positions of X41 and X42 are in the first region; however, in the case where the flow proceeds to step S64B, the operator has input the operation in the second region, and therefore the operation is unaffected even if antinodes of the standing wave are positioned at X41 and X42.

Thus, when the operator touches the GUI button 62 or the GUI button 63, the operator can recognize the positions of the GUI button 62 or the GUI button 63 from the oscillation of the standing wave. Therefore, the operator can immediately recognize the positions of the GUI button 62 or the GUI button 63 in the second region, based on only the feeling perceived by touching the coordinate input screen page (surface of the surface substrate 4).

When the main control device 9 determines that the pressing force is greater than or equal to a predetermined threshold in step S62, the main control device 9 reads, from the memory 10, a driving pattern (operation completion driving pattern) for generating an oscillation for the GUI buttons 61, 62, and 63, so that the operator is notified that the operation has been completed based on the perceived feeling (step S64C).

After step S64C, in step S65, the main control device 9 inputs the driving pattern (operation completion driving pattern) generated in step S64C to the drive control circuit 8, and drives the piezoelectrically-actuated devices 5A and 5B.

The operation completion driving pattern may be any pattern as long as the frequency, the phase difference, or the amplitude for driving the piezoelectrically-actuated devices 5A and 5B can be changed so that the operator is notified that the operation has been completed by perceiving a changed feeling.

The processes of step S64C and step S65 performed after S64C are executed by the main control device 9.

The main control device 9 determines whether the process according to the program for providing a service to the operator has ended (step S66). For example, when the touch-panel-equipped display device according to the sixth embodiment is used in an ATM, the process of step S66 may be implemented by determining whether a program for dispensing cash or transferring cash has ended.

When the main control device 9 has determined that the program has not ended in step S66, the flow returns to step S61. The main control device 9 repeats the process starting from step S61.

With the touch panel device and the touch-panel-equipped display device according to the sixth embodiment of the present invention, even if GUI elements (buttons) having different center positions and boundary positions are displayed as shown in FIG. 21, the following configuration is implemented. That is, the positions where the GUI elements are displayed are divided into different regions, and the driving pattern of the piezoelectrically-actuated devices 5A and 5B for generating a standing wave is changed according to the input operation (according to the region including the GUI element that is operated). Therefore, standing waves can be generated according to GUI elements that have various sizes and that are arranged in various patterns. Accordingly, with a touch panel device that displays various types of GUI elements and a touch-panel-equipped display device including such a touch panel device, the operator can immediately recognize the position of the GUI element based on only the perceived feeling, thereby providing excellent operability.

The above-described touch panel devices and touch-panel-equipped display devices and methods of controlling the touch panel devices according to the first to sixth embodiments may be freely combined.

The present invention is not limited to the specifically disclosed embodiment, and variations and modifications may be made without departing from the scope of the present invention.

The present application is based on Japanese Priority Application No. 2009-060259 filed on Mar. 12, 2009 and Japanese Priority Application No. 2010-008428 filed on Jan. 18, 2010 with the Japan Patent Office, the entire contents of which are hereby incorporated by reference.

1. A touch panel device comprising:
an input screen page;
an operation element generating unit configured to generate one or more operation elements to be displayed as one or more images on a display unit positioned underneath the input screen page;
an oscillation generating unit configured to generate an oscillation for oscillating the input screen page; and
a drive control unit configured to drive and control the oscillation generating unit with the use of a driving pattern for generating a standing wave having a waveform in accordance with positions of the one or more operation elements.

2. The touch panel device according to claim 1, wherein
the drive control unit drives and controls the oscillation generating unit with the use of the driving pattern for generating the standing wave having a waveform in accordance with sizes of the one or more operation elements.

3. The touch panel device according to claim 1, wherein
the driving pattern includes a driving pattern used for driving and controlling the oscillation generating unit by a unique oscillation frequency of the input screen page.

4. The touch panel device according to claim 1, wherein
the driving pattern includes a driving pattern used for driving and controlling the oscillation generating unit such that antinodes or nodes of the standing wave are positioned at center positions of the one or more operation elements or at boundaries between the one or more operation elements.

5. The touch panel device according to claim 1, further comprising:
a proximity degree detecting unit configured to detect a proximity degree of an operator of the touch panel device with respect to the input screen page; and
a proximity degree determining unit configured to determine whether the proximity degree detected by the proximity degree detecting unit is larger than or equal to a predetermined degree,
wherein when the proximity degree determining unit determines that the proximity degree is larger than or equal to the predetermined degree, the drive control unit starts to drive and control the oscillation generating unit with the use of the driving pattern.

6. The touch panel device according to claim 1, further comprising:
an identification information reading unit configured to read identification information of an operator of the touch panel device;
a storing unit configured to store the identification information of the operator and the driving pattern corresponding to the operator, in association with each other; and
a driving pattern reading unit configured to read, from the storing unit, the driving pattern associated with the identification information read by the identification information reading unit,
wherein the drive control unit drives and controls the oscillation generating unit with the use of the driving pattern read by the driving pattern reading unit.

7. The touch panel device according to claim 1, wherein
according to passage of time, the drive control unit changes positions of antinodes or nodes of the standing wave generated with the use of the driving pattern, or changes an amplitude or a frequency of the standing wave generated with the use of the driving pattern.

8. The touch panel device according to claim 1, wherein
the drive control unit drives and controls the oscillation generating unit with the use of the driving pattern for generating the standing wave having the waveform in accordance with sizes, shapes, or the positions of the one or more operation elements.

9. The touch panel device according to claim 1, wherein
the drive control unit controls the driving pattern such that positions of antinodes or nodes of the standing wave are controlled in accordance with a position at which an operation is input onto the input screen page.

10. The touch panel device according to claim 1, further comprising:
a pressing force detecting unit configured to detect a pressing force of an operation input onto the input screen page by an operator of the touch panel device; and
a pressing force determining unit configured to determine whether the pressing force detected by the pressing force detecting unit is greater than or equal to a predetermined threshold,
wherein when the pressing force determining unit determines that the pressing force of the operation detected by the pressing force detecting unit is less than the predetermined threshold, the drive control unit drives and controls the oscillation generating unit with the use of the driving pattern, and
when the pressing force determining unit determines that the pressing force of the operation detected by the pressing force detecting unit is greater than or equal to the predetermined threshold, the drive control unit drives and controls the oscillation generating unit with the use of another driving pattern other than the driving pattern.

11. The touch panel device according to claim 10, wherein
the other driving pattern is used for driving and controlling the oscillation generating unit such that the operator of the touch panel device perceives that the operation input to the one or more operation elements has been completed.

12. A touch-panel-equipped display device comprising:
the touch panel device according to claim 1; and
the display unit configured to display the one or more operation elements generated by the operation element generating unit as one or more images.

13. A control method for controlling a touch panel device, comprising:
generating one or more operation elements to be displayed as one or more images on a display unit positioned underneath an input screen page;
generating an oscillation for oscillating the display unit; and
controlling the step of generating the oscillation with the use of a driving pattern for generating a standing wave having a waveform in accordance with positions of the one or more operation elements.
